(19) United States
(12) Patent Application Publication
(10) Pub. No.: US 2025/0247280 A1
(43) Pub. Date: Jul. 31, 2025

(54) EXTENDED LONG RANGE (ELR) PHYSICAL LAYER PROTOCOL DATA UNIT (PPDU) DESIGN

(71) Applicant: QUALCOMM Incorporated, San Diego, CA (US)

(72) Inventors: Lin YANG, San Diego, CA (US); Bin TIAN, San Diego, CA (US); Youhan KIM, Saratoga, CA (US)

(21) Appl. No.: 18/423,248

(22) Filed: Jan. 25, 2024

(51) Int. Cl. H04L 27/26; H04L 27/20

(52) U.S. Cl. CPC H04L 27/2603; H04L 27/2082; H04L 27/2605; H04L 27/2614

(57) ABSTRACT

This disclosure provides methods, components, devices and systems for extended long range (ELR) physical layer protocol data unit (PPDU) design. In some implementations, a first wireless device may a preamble of the PPDU, where a first portion of the PPDU may include one or more legacy fields, such as at least a legacy signal (L-SIG) field. In some examples, a second portion of the preamble may include at least a first ELR signature field indicating that the PPDU is associated with ELR communications. In such implementations the at least first ELR signature field may follow the L-SIG field. A second wireless device, the receiver of the PPDU, may identify that the PPDU is associated with ELR communications based on the ELR signature field being included in the preamble of the PPDU.

### TECHNICAL FIELD

This disclosure relates generally to wireless communication and, more specifically, to extended long range (ELR) physical layer protocol data unit (PPDU) design.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, one or more wireless devices, such as wireless APs or wireless STAs, may communicate over a coverage region that is extended relative to other communications. Such communications may be referred to as extended long range (ELR) communications.

### SUMMARY

The systems, methods, and devices of this disclosure each have several innovative aspects, no single one of which is solely responsible for the desirable attributes disclosed herein.

One innovative aspect of the subject matter described in this disclosure can be implemented by as a method for wireless communications by a first wireless device. The method may include transmitting a preamble of a physical layer protocol data unit (PPDU), where a first portion of the preamble includes at least a legacy signal (L-SIG) field and where a second portion of the preamble includes at least a first extended long range (ELR) signature field indicating that the PPDU is associated with ELR communications, the first ELR signature field carrying a first sequence recognized by a second wireless device and occupying at least a first set of multiple tones of at least a first symbol of the second portion of the preamble, where at least the L-SIG field of the first portion of the preamble precedes the first ELR signature field.

Another innovative aspect of the subject matter described in this disclosure can be implemented by a first wireless device. The first wireless device may include a processing system that includes processor circuitry and memory circuitry that stores code. The processing system may be configured to cause the first wireless device to transmit a PPDU, where a first portion of the preamble includes at least a L-SIG field and where a second portion of the preamble includes at least a first ELR signature field indicating that the PPDU is associated with ELR communications, the first ELR signature field carrying a first sequence recognized by a second wireless device and occupying at least a first set of multiple tones of at least a first symbol of the second portion of the preamble, where at least the L-SIG field of the first portion of the preamble precedes the first ELR signature field.

Another innovative aspect of the subject matter described in this disclosure can be implemented by a first wireless device. The first wireless device may include means for transmitting a PPDU, where a first portion of the preamble includes at least a L-SIG field and means for where a second portion of the preamble includes at least a first ELR signature field indicating that the PPDU is associated with ELR communications, the first ELR signature field carrying a first sequence recognized by a second wireless device and occupying at least a first set of multiple tones of at least a first symbol of the second portion of the preamble, where at least the L-SIG field of the first portion of the preamble precedes the first ELR signature field.

Another innovative aspect of the subject matter described in this disclosure can be implemented by a non-transitory computer-readable medium storing code. The code may include instructions executable by one or more processors transmit a PPDU, where a first portion of the preamble includes at least a L-SIG field and where a second portion of the preamble includes at least a first ELR signature field indicating that the PPDU is associated with ELR communications, the first ELR signature field carrying a first sequence recognized by a second wireless device and occupying at least a first set of multiple tones of at least a first symbol of the second portion of the preamble, where at least the L-SIG field of the first portion of the preamble precedes the first ELR signature field.

In some examples of the method, first wireless devices, and non-transitory computer-readable medium described herein, the second portion of the preamble further includes a second ELR signature field carrying a second sequence recognized by the second wireless device and occupying a second set of multiple tones of a second symbol of the second portion of the preamble, the first ELR signature field preceding the second ELR signature field in the second portion of the preamble.

In some examples of the method, first wireless devices, and non-transitory computer-readable medium described herein, the first sequence of the first ELR signature field may be equivalent to the second sequence of the second ELR signature field.

In some examples of the method, first wireless devices, and non-transitory computer-readable medium described herein, the second sequence of the second ELR signature field may be different from the first sequence of the first ELR signature field.

In some examples of the method, first wireless devices, and non-transitory computer-readable medium described herein, the second set of multiple tones may be different from the first set of multiple tones.

In some examples of the method, first wireless devices, and non-transitory computer-readable medium described herein, the second set of multiple tones may be the same as the first set of multiple tones.

In some examples of the method, first wireless devices, and non-transitory computer-readable medium described herein, the first ELR signature field may be transmitted according to a first modulation scheme, and the second ELR signature field may be transmitted according to a second modulation scheme.

In some examples of the method, first wireless devices, and non-transitory computer-readable medium described herein, the first ELR signature field and the second ELR signature field may be transmitted according to a same modulation scheme.

In some examples of the method, first wireless devices, and non-transitory computer-readable medium described herein, the second portion of the preamble further includes a third ELR signature field carrying a third sequence recognized by the second wireless device and occupying a third set of multiple tones of a third symbol of the second portion of the preamble, the second ELR signature field preceding the third ELR signature field in the second portion of the preamble.

In some examples of the method, first wireless devices, and non-transitory computer-readable medium described herein, the third sequence of the third ELR signature field may be a repetition of the first sequence of the first ELR signature field.

In some examples of the method, first wireless devices, and non-transitory computer-readable medium described herein, the first ELR signature field occupies a subset of the first set of multiple tones.

In some examples of the method, first wireless devices, and non-transitory computer-readable medium described herein, the first portion of the preamble of the PPDU further includes a repeat legacy signal (RL-SIG) field, and the RL-SIG field of the first portion of the preamble precedes the first ELR signature field.

In some examples of the method, first wireless devices, and non-transitory computer-readable medium described herein, the first portion of the preamble of the PPDU includes one or more universal signal (U-SIG) fields, and the one or more U-SIG fields of the first portion of the preamble precede the first ELR signature field.

In some examples of the method, first wireless devices, and non-transitory computer-readable medium described herein, the first sequence of the first ELR signature field may be transmitted according to a modulation scheme that may be in accordance with a binary phase shift keying (BPSK) modulation associated with a phase rotation.

In some examples of the method, first wireless devices, and non-transitory computer-readable medium described herein, the modulation scheme includes one of the BPSK modulation scheme, a quadrature BPSK (QBPSK) modulation scheme, a reversed BPSK modulations scheme, a combination of the BPSK modulation scheme and the QBPSK modulation scheme, a combination of the BPSK modulation scheme and the reversed BPSK modulation scheme.

In some examples of the method, first wireless devices, and non-transitory computer-readable medium described herein, the first ELR signature field may be partially inverse to the L-SIG field.

In some examples of the method, first wireless devices, and non-transitory computer-readable medium described herein, the first ELR signature field further indicates a basic service set identifier associated with the ELR communications.

In some examples of the method, first wireless devices, and non-transitory computer-readable medium described herein, the first ELR signature field may be equivalent to a legacy long training field (L-LTF) included in the first portion of the preamble of the PPDU.

In some examples of the method, first wireless devices, and non-transitory computer-readable medium described herein, the first sequence of the first ELR signature field includes a sequence associated with a U-SIG field with a physical version number associated with the ELR communications.

In some examples of the method, first wireless devices, and non-transitory computer-readable medium described herein, the first sequence of the first ELR signature field may be selected in accordance with a peak to average power ratio (PAPR) associated with the ELR communications.

In some examples of the method, first wireless devices, and non-transitory computer-readable medium described herein, channel estimation of a channel between the first wireless device and the second wireless device may be measured in accordance with the first set of multiple tones of the first symbol used to transmit the first ELR signature field.

One innovative aspect of the subject matter described in this disclosure can be implemented by as a method for wireless communications by a wireless device. The method may include receiving a PPDU, where a first portion of the preamble includes at least a L-SIG field and where a second portion of the preamble includes at least a first ELR signature field indicating that the PPDU is associated with ELR communications, the first ELR signature field carrying a first sequence recognized by the wireless device and occupying at least a first set of multiple tones of at least a first symbol of the second portion of the preamble, where at least the L-SIG field of the first portion of the preamble precedes the first ELR signature field.

Another innovative aspect of the subject matter described in this disclosure can be implemented by a wireless device. The wireless device may include a processing system that includes processor circuitry and memory circuitry that stores code. The processing system may be configured to cause the wireless device to receive a PPDU, where a first portion of the preamble includes at least a L-SIG field and where a second portion of the preamble includes at least a first ELR signature field indicating that the PPDU is associated with ELR communications, the first ELR signature field carrying a first sequence recognized by the wireless device and occupying at least a first set of multiple tones of at least a first symbol of the second portion of the preamble, where at least the L-SIG field of the first portion of the preamble precedes the first ELR signature field.

Another innovative aspect of the subject matter described in this disclosure can be implemented by a wireless device. The wireless device may include means for receiving a PPDU, where a first portion of the preamble includes at least a L-SIG field and means for where a second portion of the preamble includes at least a first ELR signature field indicating that the PPDU is associated with ELR communications, the first ELR signature field carrying a first sequence recognized by the wireless device and occupying at least a first set of multiple tones of at least a first symbol of the second portion of the preamble, where at least the L-SIG field of the first portion of the preamble precedes the first ELR signature field.

Another innovative aspect of the subject matter described in this disclosure can be implemented by a non-transitory computer-readable medium storing code. The code may include instructions executable by one or more processors to receive a PPDU, where a first portion of the preamble includes at least a L-SIG field and where a second portion of the preamble includes at least a first extend long range (ELR) signature field indicating that the PPDU is associated with ELR communications, the first ELR signature field carrying a first sequence recognized by the wireless device and occupying at least a first set of multiple tones of at least a first symbol of the second portion of the preamble, where at least the L-SIG field of the first portion of the preamble precedes the first ELR signature field.

In some examples of the method, wireless devices, and non-transitory computer-readable medium described herein, the second portion of the preamble includes a second ELR signature field carrying a second sequence recognized by the wireless device and occupying a second set of multiple tones of a second symbol of the second portion of the preamble, the first ELR signature field preceding the second ELR signature field in the second portion of the preamble.

In some examples of the method, wireless devices, and non-transitory computer-readable medium described herein, the first sequence of the first ELR signature field may be equivalent to the second sequence of the second ELR signature field.

In some examples of the method, wireless devices, and non-transitory computer-readable medium described herein, the second sequence of the second ELR signature field may be different from the first sequence of the first ELR signature field.

In some examples of the method, wireless devices, and non-transitory computer-readable medium described herein, the second set of multiple tones may be different from the first set of multiple tones.

In some examples of the method, wireless devices, and non-transitory computer-readable medium described herein, the second set of multiple tones may be the same as the first set of multiple tones.

In some examples of the method, wireless devices, and non-transitory computer-readable medium described herein, the first ELR signature field may be received according to a first modulation scheme, and the second ELR signature field may be received according to a second modulation scheme.

In some examples of the method, wireless devices, and non-transitory computer-readable medium described herein, the first ELR signature field and the second ELR signature field may be received according to a same modulation scheme.

In some examples of the method, wireless devices, and non-transitory computer-readable medium described herein, the second portion of the preamble includes a third ELR signature field carrying a third sequence recognized by the wireless device and occupying a third set of multiple tones of a third symbol of the second portion of the preamble, the second ELR signature field preceding the third ELR signature field in the second portion of the preamble.

In some examples of the method, wireless devices, and non-transitory computer-readable medium described herein, the third sequence of the third ELR signature field may be a repetition of the first sequence of the first ELR signature field.

In some examples of the method, wireless devices, and non-transitory computer-readable medium described herein, the first ELR signature field occupies a subset of the first set of multiple tones.

In some examples of the method, wireless devices, and non-transitory computer-readable medium described herein, the first portion of the preamble of the PPDU further includes a RL-SIG field, and the RL-SIG field of the first portion of the preamble precedes the first ELR signature field.

In some examples of the method, wireless devices, and non-transitory computer-readable medium described herein, the first portion of the preamble of the PPDU includes one or more U-SIG fields, and the one or more U-SIG fields of the first portion of the preamble precede the first ELR signature field.

In some examples of the method, wireless devices, and non-transitory computer-readable medium described herein, the first ELR signature field may be received according to a modulation scheme that may be in accordance with a BPSK modulation scheme with a phase rotation.

In some examples of the method, wireless devices, and non-transitory computer-readable medium described herein, the modulation scheme includes one of the BPSK modulation scheme, QBPSK modulation scheme, a reversed BPSK modulations scheme, a combination of the BPSK modulation scheme and the QBPSK modulation scheme, a combination of the BPSK modulation scheme and the reversed BPSK modulation scheme.

In some examples of the method, wireless devices, and non-transitory computer-readable medium described herein, the first sequence of the first ELR signature field may be partially inverse to the L-SIG field.

In some examples of the method, wireless devices, and non-transitory computer-readable medium described herein, the first sequence of the first ELR signature field further indicates a basic service set identifier associated with the ELR communications.

In some examples of the method, wireless devices, and non-transitory computer-readable medium described herein, the first sequence of the first ELR signature field may be equivalent to a L-LTF included in the first portion of the preamble of the PPDU.

In some examples of the method, wireless devices, and non-transitory computer-readable medium described herein, the first sequence of the first ELR signature field includes a sequence associated with U-SIG field with a physical version number associated with the ELR communications.

In some examples of the method, wireless devices, and non-transitory computer-readable medium described herein, the first ELR signature field may be selected in accordance with a PAPR associated with the ELR communications.

Some examples of the method, wireless devices, and non-transitory computer-readable medium described herein may further include operations, features, means, or instructions for performing channel estimation of a channel between the wireless device and a second wireless device using the first set of multiple tones of the first symbol.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network, such as an extended long range (ELR) communication network between two wireless devices.

FIG. 2 shows an example protocol data unit (PDU) usable for communications between a wireless access point (AP) and one or more wireless stations (STAs) in an ELR communication network.

FIG. 3A, FIG. 3B, FIG. 3C, and FIG. 3D show examples of physical layer (PHY) protocol data units (PPDUs) usable for communications between a wireless AP and one or more wireless STAs in an ELR communication network.

FIG. 4 shows an example of a signaling diagram that illustrates transmission of a PPDU including one or more ELR identifiers (ELR-IDs) that indicate the PPDU is associated with ELR communications.

FIG. 5 shows an example of a signaling diagram that illustrates transmission of a PPDU including one or more ELR-IDs following a legacy signal field, where the ELR-IDs indicate the PPDU is associated with ELR communications.

FIG. 6 shows an example of a signaling diagram that illustrates transmission of a PPDU including one or more ELR-IDs following a repeat legacy signal field, where the ELR-IDs indicate the PPDU is associated with ELR communications.

FIG. 7 shows an example of a signaling diagram that illustrates transmission of a PPDU including one or more ELR-IDs following one or more universal signal fields, where the ELR-IDs indicate the PPDU is associated with ELR communications.

FIG. 8 shows an example of a process flow that illustrates transmission of a PPDU a first portion and a second portion, where the second portion includes one or more ELR-IDs indicating that the PPDU is associated with ELR communications.

FIG. 9 shows a block diagram of an example wireless communication device that supports ELR PPDU design by implementation of one or more components within the wireless communication device.

FIG. 10 shows a block diagram of an example wireless communication device that ELR PPDU design by implementation of one or more components within the wireless communication device.

FIGS. 11 and 12 show flowcharts illustrating example processes performable by or at a wireless device that supports ELR PPDU design.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to extended long range (ELR) physical protocol data unit (PPDU) formats. In some implementations, one or more wireless devices, such as wireless stations (STAs), wireless access points (APs), or both in a WLAN communications system, may extend a distance, or coverage range, over which wireless communications are provided. For example, a first wireless device may communicate with a second wireless device over a distance that is extended relative to other WLAN communication systems. To facilitate such ELR communications, the wireless devices may utilize a PPDU that is designed to obtain a target data rate over the extended coverage range. Accordingly, the first wireless device may transmit the PPDU, formatted according to the ELR communications, to a second wireless device, such that the second wireless device may detect and decode the packet. In such examples, the second wireless device may attempt to identify whether the packet is associated with, such as intended for, ELR communications, for example, by performing one or more hypothesis tests. However, performance of one or more hypothesis tests may increase the complexity of packet detection at the second wireless device. Such complexity may lead to an increase in lost or misinterpreted PPDUs during ELR communications, thereby increasing latency in the ELR communications.

As described herein, the one or more wireless devices may implement a PPDU design that enables the second wireless device to detect a PPDU relatively quickly, while also reducing the complexity of such tests. For example, a first wireless device may transmit a first portion of a preamble of the PPDU, where the first portion of the PPDU may include one or more legacy fields, such as a legacy signal (L-SIG) field, a repeat legacy signal field (RL-SIG), one or more universal signal fields (U-SIGs), or a combination of each. Based on transmitting the first portion of the preamble, the first wireless device may transmit a second portion of the preamble, where the second portion of the preamble includes at least a first ELR signature field including a first sequence the second wireless device, where the first sequence indicates to the second wireless device that the PPDU is associated with ELR communications. As such, a second wireless device, such as the receiver of the PPDU, may identify that the PPDU is associated with ELR communications based on the first sequence of the first ELR signature field being included in the preamble of the PPDU.

In such examples, the first wireless device may transmit the first ELR signature field following the transmission of the L-SIG field of the first portion of the preamble. Alternatively, if the first portion of the preamble includes the RL-SIG field, the first wireless device may transmit the first ELR signature field following the transmission of the RL-SIG field. In some examples, if the first portion of the preamble includes the U-SIG fields, the first wireless device may transmit the ELR signature field following the transmission of the one or more U-SIG fields. Additionally, to increase the likelihood of reception for the second wireless device, the first wireless device may transmit one or more additional ELR signature fields, such as a second ELR signature field or a third ELR signature field, following the first ELR signature field.

In some implementations, to distinguish the PPDU from existing PPDU formats, the first sequence, such as the bits of the first ELR signature field, may be a partial inverse of a sequence of the L-SIG field, be equivalent to a legacy long training field (L-LTF) included in the first portion of the preamble, or be a U-SIG sequence with a different or unused physical version number than a sequence transmitted via the U-SIG field of the first portion of the preamble. In some other implementations, the first sequence may further indicate a basic service set (BSS) identifier (ID). In some implementations, the first wireless device may select the first sequence to minimize the peak to average power ratio (PAPR) of the first symbol carrying the first ELR signature in the time domain.

Particular aspects of the subject matter described in this disclosure can be implemented to realize one or more of the following potential advantages. In some examples, by including the first ELR signature field within the preamble of the PPDU, the described techniques can be used by the second wireless device to identify whether the PPDU is associated with ELR communications in an effective manner, thereby reducing the likelihood of lost or misinterpreted packets by the second wireless device. Additionally, by transmitting one or more additional ELR signature fields as part of the second portion of the preamble, the second wireless device may have an increased likelihood of receiving at least one of the ELR signature fields, thereby reducing the likelihood of misinterpreting or losing the PPDU. By selecting the first sequence according to the PAPR of the channel, the first wireless device may transmit the first ELR signature field with less distortion and an increase in power boosting, thereby increasing the reliability of reception at the second wireless device. This increased reliability of reception may improve throughput and user experience with respect to the wireless communications, resulting in increased power and spectral efficiency. Accordingly, ELR signature fields with a known sequence at the first wireless device, such as the transmitter, and the second wireless device, such as the receiver, may be used for boosting channel estimation. Additionally, in the example of using two or three ELR signature fields with a simple repetition between each of the ELR signature fields, the wireless devices may improve frequency tracking for ELR PPDU decoding.

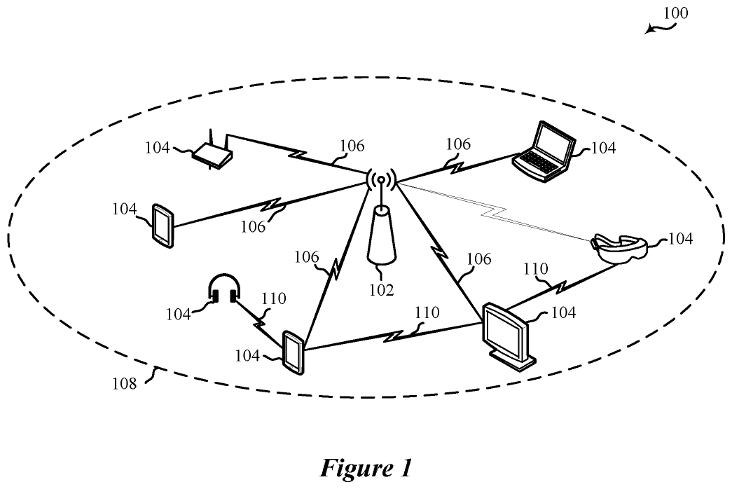

FIG. 1 shows a pictorial diagram of an example wireless communication network 100, such as an extended long range (ELR) communication network between two wireless devices. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.122 GHZ), FR2 (24.22 GHZ-52.6 GHz), FR3 (7.122 GHz-24.22 GHz), FR4a or FR4-1 (52.6 GHz-71 GHz), FR4 (52.6 GHz-114.22 GHz), and FR5 (114.22 GHz-240 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some implementations, one or more STAs 104, one or more APs 102, or a combination of such wireless devices, may communicate over a coverage range that is extended relative to other communications systems. In such implementations, the wireless devices may utilize a PPDU format that is designed to obtain target data rates over the extended coverage range, while also reducing the complexity of packet detection and identification at the receiving wireless device. Accordingly, a first wireless device, such as a transmitting STA 104 or AP 102, may transmit, via a preamble of a PPDU, one or more ELR signature fields that indicate the PPDU is associated with ELR communications. For example, the first wireless device may transmit the one or more ELR signature fields following a legacy signal field (L-SIG) of the PPDU, following a repeat L-SIG (RL-SIG) of the PPDU, or following one or more universal signal (U-SIG) fields of the PPDU. As such, a second wireless device, such as a receiving STA 104 or AP 102, may receive the preamble of the PPDU and perform packet identification and detection according to the one or more ELR signature fields. That is, based on the presence of the one or more ELR signature fields, the second wireless device may identify that the PPDU is associated with ELR communications, thereby reducing complexity at the second wireless device.

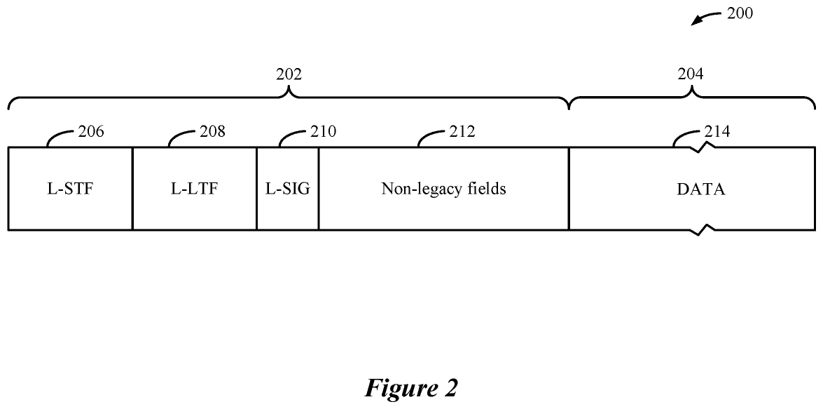

FIG. 2 shows an example protocol data unit (PDU) 200 usable for wireless communication between a wireless AP and one or more wireless STAs in an ELR communication network. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a L-SIG 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

The PDU 200 may be configured as one or more existing PPDU formats, such as a 11a PPDU format, a high throughput (HT) greenfield (GF) PPDU format, a HT mixed function (MF) PPDU format, a very HT (VHT) PPDU format, a high efficiency (HE) single user format, a HE trigger based (TB) PPDU format, a HE multi user (MU) PPDU format, a HE extended range (ER) SU PPDU format, a wake up radio (WUR) PPDU format, an extremely high throughput (EHT) MU PPDU format, a EHT TB PPDU format, a ER SU PPDU format, or a post-11be PPDU format.

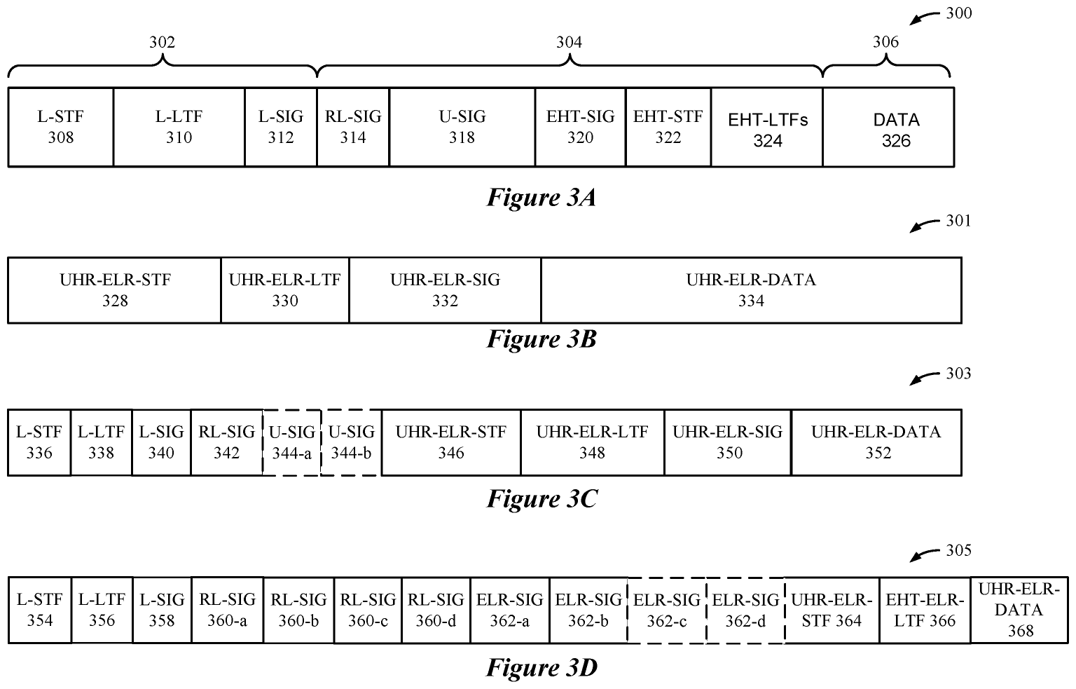

FIG. 3A shows an example of a PPDU 300 usable for communications between a wireless AP and one or more wireless STAs in an ELR communication network. For example, the AP and STAs may be examples of the AP 102 and the STAs 104 described with reference to FIG. 1. As shown, the PPDU 300 includes a PHY preamble, that includes a first portion 302 and a second portion 304, and a payload 306 that includes a data field 326. The first portion 302 of the preamble includes an L-STF 308, an L-LTF 310, and an L-SIG 312. The second portion 304 of the preamble includes a RL-SIG 314 and multiple wireless communication protocol version-dependent signal fields after RL-SIG 314. For example, the second portion 304 may include a U-SIG field 318 (referred to herein as “U-SIG 318”) and an EHT signal field 320 (referred to herein as “EHT-SIG 320”). The presence of RL-SIG 314 and U-SIG 318 may indicate to EHT- or later version-compliant STAs 104 that the PPDU 300 is an EHT PPDU or a PPDU conforming to any later (post-EHT) version of a new wireless communication protocol conforming to a future IEEE 802.11 wireless communication protocol standard. One or both of U-SIG 318 and EHT-SIG 320 may be structured as, and carry version-dependent information for, other wireless communication protocol versions associated with amendments to the IEEE family of standards beyond EHT. For example, U-SIG 318 may be used by a receiving device (such as an AP 102 or a STA 104) to interpret bits in one or more of EHT-SIG 320 or the data field 326. Like L-STF 308, L-LTF 310, and L-SIG 312, the information in U-SIG 318 and EHT-SIG 320 may be duplicated and transmitted in each of the component 20 MHz channels in instances involving the use of a bonded channel.

The second portion 304 further includes an additional short training field 322 (referred to herein as “EHT-STF 322,” although it may be structured as, and carry version-dependent information for, other wireless communication protocol versions beyond EHT) and one or more additional long training fields 324 (referred to herein as “EHT-LTFs 324,” although they may be structured as, and carry version-dependent information for, other wireless communication protocol versions beyond EHT). EHT-STF 322 may be used for timing and frequency tracking and AGC, and EHT-LTF 324 may be used for more refined channel estimation.

EHT-SIG 320 may be used by an AP 102 to identify and inform one or multiple STAs 104 that the AP 102 has scheduled uplink (UL) or downlink (DL) resources for them. EHT-SIG 320 may be decoded by each compatible STA 104 served by the AP 102. EHT-SIG 320 may generally be used by the receiving device to interpret bits in the data field 326. For example, EHT-SIG 320 may include resource unit (RU) allocation information, spatial stream configuration information, and per-user (such as STA-specific) signaling information. Each EHT-SIG 320 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 326.

In some implementations, the wireless devices may utilize a PPDU 300 format that is designed to obtain target data rates over the extended coverage range, while also reducing the complexity of packet detection and identification at the receiving wireless device. Accordingly, a first wireless device, such as a transmitting STA 104 or AP 102, may transmit, via a preamble of a PPDU 300, one or more ELR signature fields that indicate the PPDU 300 is associated with ELR communications. For example, the first wireless device may transmit the one or more ELR signature fields following the L-SIG 312 of the PPDU 300, following the RL-SIG 314 of the PPDU 300, or following the U-SIG 318 of the PPDU 300. As such, a second wireless device, such as a receiving STA 104 or AP 102, may receive the preamble of the PPDU 300 and perform packet identification and detection according to the one or more ELR signature fields. That is, based on the presence of the one or more ELR signature fields, the second wireless device may identify that the PPDU 300 is associated with ELR communications, thereby reducing complexity at the second wireless device.

FIG. 3B shows an example of a PPDU 301 usable for communications between a wireless AP and one or more wireless STAs in an ELR communication network. In some implementations, the PPDU 301 may be an ELR GF PPDU, which may include a preamble, where the preamble includes an ultra-high reliability (UHR) ELR-STF 328, a UHR-ELR-LTF 330, and a UHR-ELR-SIG 332. Additionally, the PPDU 301 also may include a UHR-ELR-DATA 334. The wireless devices may utilize the PPDU 301 for short ELR requests (ELR-RTSs) and to protect the UHR-ELR-DATA 334, where UHR-ELR-DATA 334 may include an increased quantity of data.

The first wireless device may transmit the PPDU 301 in an efficient and simple manner, for example, by not spoofing the preamble, which may reduce the overhead of the PPDU 301. In such implementations, the PPDU 301 may not include one or more legacy fields in the preamble, such that the legacy preamble coverage may be limited, thereby making the PPDU 301 detectable by the other by standing wireless devices, such as ELR legacy receivers. In the PPDU 301, the second wireless device, such as the receiver, may utilize the UHR-ELR-STF 328 for packet detection and ELR mode classification. For example, the UHR-ELR-STF 328 may carry the same sequence as a L-STF, such as the L-STF 308, but be transmitted with a 3 dB boosting over a fixed frequency offset, such as 625 kHz for classification. In this way, the second wireless device may perform packet detection using an augmented autocorrect based algorithm and perform ELR mode classification using the 625 kHz offset. Additionally, the first wireless device may transmit the UHR-ELR-STF 328 with 3 dB power boosting and transmit the UHR-ELR-SIG 332 and UHR-ELR-DATA 334 with multiple repetitions, such as 4 repetitions.

FIG. 3C shows an example of a PPDU 303 usable for communications between a wireless AP and one or more wireless STAs in an ELR communication network. In some other implementations, the PPDU 303 may be a spoofed GF PPDU 303, which may include a preamble, where the preamble includes one or more legacy fields, such as a L-STF 336, a L-LTF 338, a L-SIG 340, a RL-SIG 342, a U-SIG 344-a, and a U-SIG 344-b, and one or more ELR fields, such as a UHR-ELR-STF 346, a UHR-ELR-LTF 348, and a UHR-ELR-SIG 350. Additionally, the PPDU 303 may include a UHR-ELR-DATA 352 field as part of a data portion of the PPDU 303.

In such implementations, the first wireless device, such as the transmitter, may transmit the PPDU 303 via two segments, where the processing at the second wireless device, such as the ELR receiver, may be relatively simple and efficient. In such implementations, the second wireless device may discard any spoofed preamble fields. Further, the first wireless device may transmit the UHR-ELR-SIG 350 after the UHR-ELR-LTF 348. The second wireless device may perform ELR packet detection and ELR mode classification according to the sequence of the UHR-ELR-STF 346, where late packet detection may increase the likelihood of collisions. The UHR-ELR-STF 346 may carry the same sequence as the sequence of the L-STF 336 but be transmitted with a 3 dB boosting over a fixed frequency offset, such as 625 kHz for mode classification. In some implementations, the second wireless device may perform ELR mode indication detection according to the UHR-ELR-LTF 348 or the UHR-ELR-SIG 350.

For example, the first wireless device may set the sequence of the UHR-ELR-LTF 348 with a reserved sequence for ELR mode indication or set the sequence of the UHR-ELR-SIG 350 with mode indication bits. For example, the first wireless device may set the sequence, such as 24 to 27 bits, of the UHR-ELR-SIG 350 to indicate the BSS ID (6+2 bits), a duration of the PPDU 303 (5-6 bits in a symbol with a duration of 16 microsecond), indicate the MCS (1 bit), indicate the CRC of the PPDU 303 (4-6 bits), and include a tail (6 bits). Additionally, the first wireless device may transmit the UHR-ELR-STF 346 with 3 dB power boosting and transmit the UHR-ELR-SIG 350 and UHR-ELR-DATA 352 with multiple repetitions, such as 4 repetitions.

FIG. 3D shows an example of a PPDU 305 usable for communications between a wireless AP and one or more wireless STAs in an ELR communication network. In some implementations, the PPDU 305 may include a preamble with one or more legacy fields, such as a L-STF 354, a L-LTF 356, a L-SIG 358, a RL-SIG 360-a, a RL-SIG 360-b, a RL-SIG 360-c, and a RL-SIG 360-d, and with one or more ELR fields, such as an ELR-SIG 362-a, an ELR-SIG 362-b, an ELR-SIG 362-c, an ELR-SIG 362-d, a UHR-ELR-STF 364, and an EHT-ELR-LTF 366. Additionally, the PPDU 305 may include a UHR-ELR-DATA 368 field. In such implementations, the first wireless device may transmit PPDU 305 via one or two segments according to the modulation schemes used to transmit the SIG and data fields.

In such implementations, the second wireless device may perform packet detection according to the L-STF 354, thereby reducing the likelihood of collisions. In such implementations, the first wireless device may transmit four repetitions of the L-SIG 358, thereby enabling the second wireless device to reuse the length of one or more legacy fields, which may reduce the information bits of the ELR-SIGs 362. Further, the second wireless device may perform ELR mode classification partly according to the four repetitions of the L-SIG 358. Using the PPDU 305, the second wireless device may perform ELR mode detection according to fields prior to the ELR-SIGs 362 or according to the ELR-SIGs 362.

In some implementations, the second wireless device may perform ELR mode detection based on a frequency offset of the transmission of the L-STF 354, according to the four repetitions of the L-SIG 358, according to the RL-SIG 360-c or the RL-SIG 360-a, which may include a 6 bit length, according to a signature sequence at the ELR-SIGs 362, according to a four repetition detection of the ELR-SIGs 362, or according to a four repetition detection of the ELR-SIGs 362 and mode indication bits included in the ELR-SIGs 362. To perform ELR mode detection according to the ELR-SIGs 362, the first wireless device may set the sequence, such as 24 to 27 bits, of one of the ELR-SIGs 362 to indicate the BSS ID (6+2 bits), a duration of the PPDU 305 (5-6 bits in a symbol with a duration of 16 microsecond), indicate the MCS (1 bit), indicate the CRC of the PPDU 305 (4-6 bits), and include a tail (6 bits).

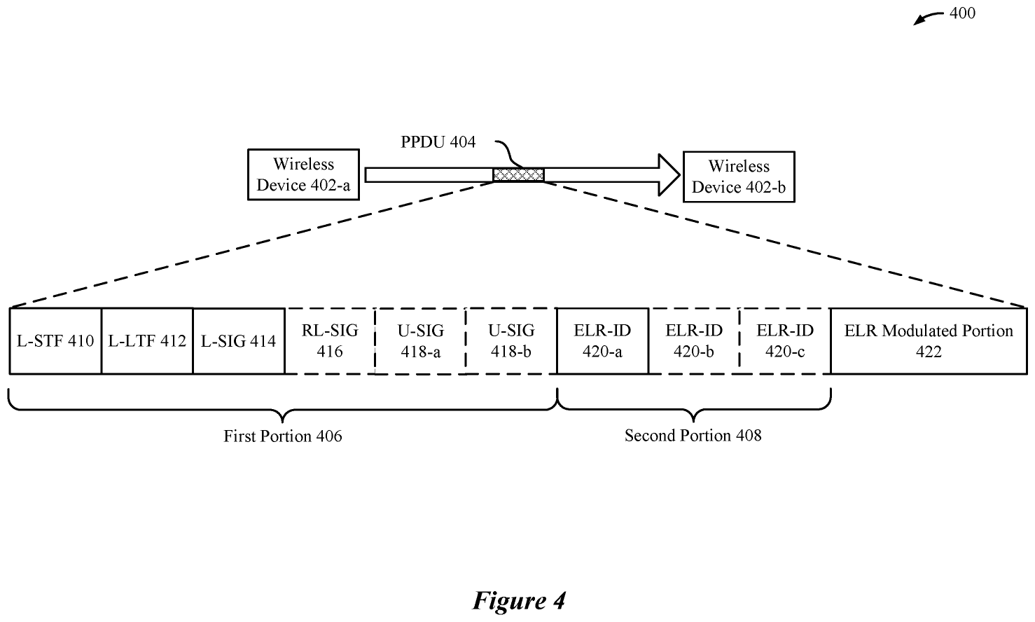

FIG. 4 shows an example of a signaling diagram 400 that illustrates transmission of a PPDU including one or more ELR identifiers (ELR-IDs) that indicate the PPDU is associated with ELR communications. Aspects of the signaling diagram 400 may implement aspects of the wireless communication network 100, the PDU 200, the PPDU 300, the PPDU 301, the PPDU 303, and the PPDU 305, as described herein with reference to FIGS. 1-3. For example, the signaling diagram 400 may include a wireless device 402-a, such as a transmitter, which may be an example of wireless STA 104 or a wireless AP 102, as described herein with reference to FIG. 1. Further, the signaling diagram 400 may include a wireless device 402-b, such as a receiver, which may be an example of wireless STA 104 or a wireless AP 102, as described herein with reference to FIG. 1. The techniques described in the context of the signaling diagram 400 may enable the wireless device 402-b to receive a PPDU 404 that includes one or more ELR-IDs 420 indicating that the PPDU 404 is associated with ELR communications.

The wireless devices 402 may perform ELR communications, during which the wireless devices 402 communicate over a coverage area, or distance, that is extended relative to other WLAN communications networks. To facilitate such ELR communications, the wireless device 402-a and the wireless device 402-b may utilize a PPDU that is designed to obtain a target data rate and throughput during communications over the extended coverage area. For example, the PPDU utilized for ELR communications may be backwards compatible, such as being formatted, or containing similar fields, as other PPDU formats described herein with reference to FIGS. 2 and 3. Additionally, the PPDU utilized for ELR communications may be formatted in a way to reduce, or otherwise limit, classification overhead.

In some examples, however, the PPDU utilized for ELR communications may lead to increased latency during ELR communications. For example, the wireless device 402-a may transmit a PPDU to the wireless device 402-b during ELR communications. In such examples, the wireless device 402-b may receive the PPDU and perform one or more hypothesis tests to determine whether the received PPDU is associated with ELR communications. In such examples, however, the wireless device 402-b may perform an increased quantity of hypothesis tests to determine the type of the PPDU, leading to increased complexity at the wireless device 402-b. Additionally, such increased quantity of hypothesis tests may incur additional hardware complexity and a relatively longer duration, as compared to a single hypothesis test, thereby increasing latency in the ELR communications system. Thus, techniques may be desired such that the wireless device 402-b may identify whether the PPDU is associated with ELR communications relatively quickly, while also reducing the complexity of operations at the wireless device 402-b.

As described herein, the wireless device 402-a may transmit a PPDU 404 that is designed, such as formatted, to reduce complexity at the wireless devices 402-b, such that the wireless device 402-b may detect the PPDU 404 relatively quickly, while avoiding multiple hypothesis tests during detection. For example, the PPDU 404 may include a PHY preamble and a PHY payload, such as the PHY preamble and PHY payload as described herein with reference to FIG. 3. The PHY preamble of the PPDU 404 may include a first portion 406 and a second portion 408. The first portion 406 may include one or more legacy fields and non-legacy fields, such as a L-STF 410, a L-LTF 412, a L-SIG 414, a RL-SIG 416, a U-SIG 418-a, or a U-SIG 418-b, which may be examples of corresponding fields described herein with reference to FIGS. 2 and 3.

The second portion 408 of the preamble may include one or more ELR-IDs 420, which may be referred to as ELR signature fields, ELR signature sequences, or the like. Such ELR-IDs 420 may indicate that the PPDU 404 is associated with, such as intended for, ELR communications. For example, each of the ELR-IDs 420 may include, such as carry a respective sequence, such as a set of bits, that are known at the wireless device 402-a and the wireless device 402-b, such that the wireless device 402-b may identify that the PPDU 404 is associated with ELR communications based on the respective sequences included in the ELR-IDs 420.

The PPDU 404 may further include an ELR modulated portion 422, which may include one or more additional fields of the PHY preamble and a data field of the PHY payload. For example, the ELR modulated portion 422 of the PPDU may include one or more ELR-STFs, one or more ELR-LTFs, one or more ELR-SIGs, where such fields may be referred to as a third portion of the preamble. Additionally, the ELR modulated portion 422 may include a data field, such as a UHR-ELR data field.

In some implementations, the wireless device 402-a may transmit the PPDU 404 via one segment or two segments according to the modulation schemes used for the SIG fields and the UHR-ELR data field. The wireless device 402-b may perform ELR packet detection according to the L-STF 410, thereby reducing the likelihood of packet collisions. In some implementations, the wireless device 402-a may not transmit, as part of the ELR modulated portion 422, one or more ELR-STFs (not shown) in the case that automatic gain control (AGC) re-setting is not performed due to relatively low signal-to-noise ratio (SNR) of the channel. Additionally, the wireless device 402-a may not transmit, as part of the ELR modulated portion 422, one or more ELR-LTFs (not shown) according to whether the PPDU 404 is transmitted via one segment or two segments.

In some implementations, the wireless device 402-a may transmit up to three ELR-IDs 420 carrying respective sequences, such as an ELR-ID 420-a, an ELR-ID 420-b, and an ELR-ID 420-c, via respective symbols as part of the second portion 408 of the preamble of the PPDU 404. For example, after transmitting the first portion 406 of the preamble of the PPDU 404, the wireless device 402-a may transmit, via a first set of tones of a first symbol, the sequence of the ELR-ID 420-a. Accordingly, the wireless device 402-b may monitor the first set of tones of the first symbol to receive the ELR-ID 420-a. In this way, the wireless device 402-a may utilize a single symbol to transmit the ELR-ID 420-a.

In such examples, however, transmission of the ELR-ID 420-a may not obtain the target data rates and throughputs of ELR communications, may not be reliable, or both. Accordingly, in some implementations, the wireless device 402-a may transmit two ELR-IDs 420, such as the ELR-ID 420-a and the ELR-ID 420-b, to meet the target data rates and increase reliability of the transmission. For example, after transmitting the first portion 406 of the preamble, the wireless device 402-a may transmit, via the first set of tones of the first symbol, the ELR-ID 420-a. Similarly, the wireless device 402-a may transmit, via a second set of tones of a second symbol, the ELR-ID 420-b. As such, the wireless device 402-b may monitor the first set of tones of first symbol to obtain the sequence of the ELR-ID 420-a and monitor the second set of tones of the second symbol to obtain the sequence of the ELR-ID 420-b. In such examples, the first symbol may precede, in time, the second symbol. In this way, the wireless devices 402 may increase the reliability of the ELR-ID transmissions.

To further increase reliability and autodetection of the second portion 408 of the preamble, the wireless device 402-a may transmit, via respective symbols, three ELR-IDs 420, such as the ELR-ID 420-a, the ELR-ID 420-b, and the ELR-ID 420-c. For example, the wireless device 402-a may transmit, via the first set of tones of the first symbol, the sequence of the ELR-ID 420-a, and transmit, via the second set of tones of the second symbol, the sequence of the ELR-ID 420-b. Similarly, the wireless device 402-a may transmit, via a third set of tones of a third symbol, the sequence of the ELR-ID 420-c. In this way, the wireless devices 402 may further increase the reliability of the ELR-ID transmissions.

In some implementations, the position of the ELR-IDs 420 in the PPDU 404 may vary between different PPDU formats. That is, the wireless device 402-a may optionally transmit the RL-SIG 416 and the U-SIGs 418 as part of the first portion 406 of the preamble of the PPDU 404. Accordingly, the wireless device 402-a may transmit the ELR-IDs 420 after the L-SIG 414, after the RL-SIG 416, or after the U-SIGs 418.

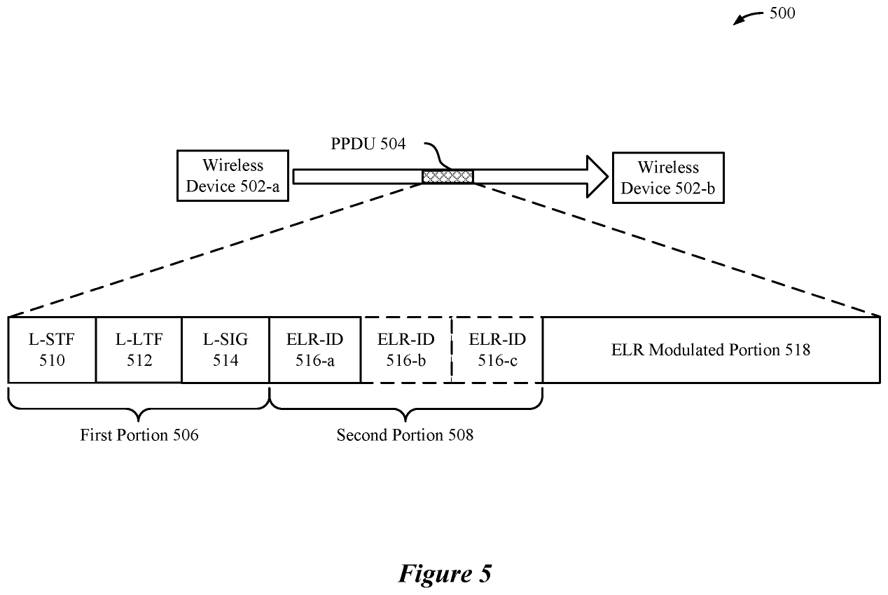

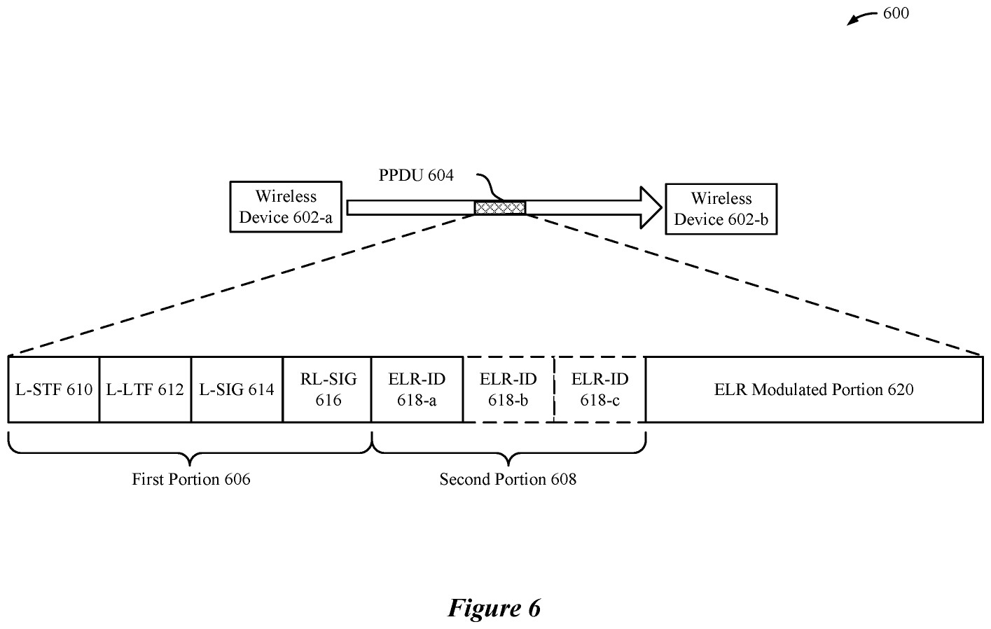

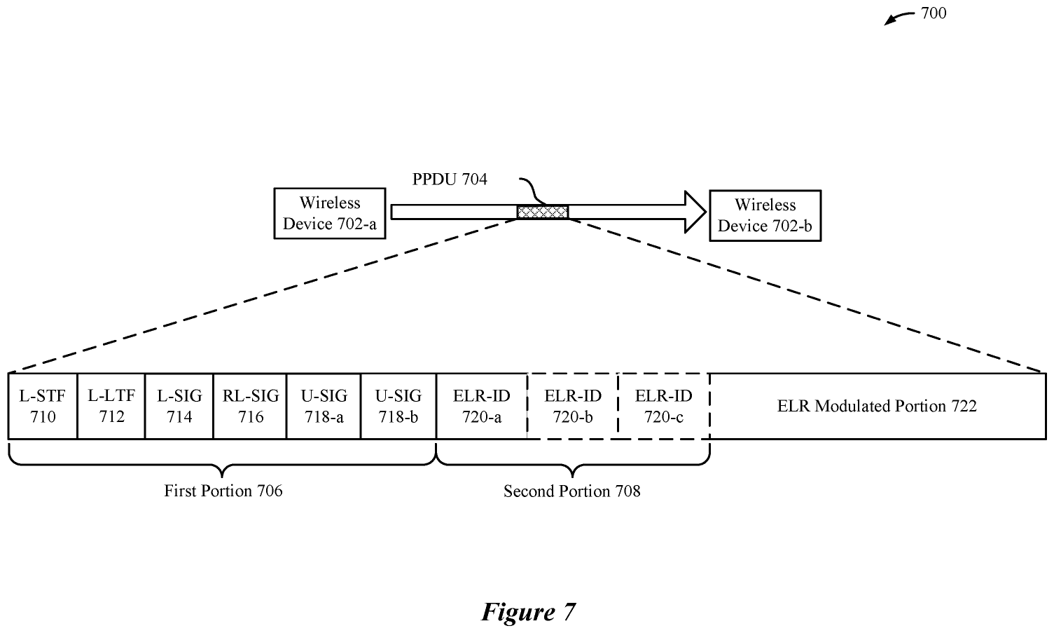

For example, the wireless device 402-a may utilize a first format of the PPDU 404, where the wireless device 402-a may transmit the ELR-IDs 420 after transmitting the L-SIG 414. Such techniques may be further described herein with reference to FIG. 5. Alternatively, the wireless device 402-a may utilize a second format of the PPDU 404, where the wireless device 402-a may transmit the ELR-IDs 420 after transmitting the RL-SIG 416. Such techniques may be further described herein with reference to FIG. 6. The wireless device 402-a may utilize a third format of the PPDU 404, where the wireless device 402-a may transmit the ELR-IDs 420 after the U-SIGs 418. Such techniques may be further described herein with reference to FIG. 7.

In some implementations, the wireless device 402-a may modulate the respective symbols, such as the first symbol, the second symbol, and the third symbol, using a binary phase shift keying (BPSK) modulation scheme. Additionally, or alternatively, the wireless device 402-a may modulate the respective symbols with a quadrature BPSK (QBPSK) modulation scheme, where the QBSPK modulation scheme may include performing the BPSK modulation with a 90 degree rotation. In some examples, the wireless device 402-a may modulate the respective symbols using a reversed BPSK modulation scheme, where the reversed BPSK modulations scheme may include performing the BPSK modulation with a 180 degree rotation. In some other examples, the wireless device 402-a may modulate the respective symbols according to a combination, such as a mix, of the BPSK modulation scheme and the QBPSK modulation scheme or a combination of the BPSK modulation scheme and the reversed BPSK modulation scheme.

In some implementations, the wireless device 402-a may transmit the ELR-IDs 420 via a subset of tones of the respective symbols, such as by populating every other tone or every X tone of the set of tones with data. That is, the wireless device may transmit the ELR-ID 420-a, such that the sequence of the ELR-ID 420-a is transmitted across a subset of the first set of tones. As an illustrative example, the first symbol may include 52 tones, such as 52 frequency ranges, where each tone may be used to transmit a single bit of data. Accordingly, the wireless device 402-a may transmit the sequence of the ELR-ID 420-a via each of the 52 tones, via a subset of the 52 tones, using every odd tone of the 52 tones, using every even tone of the 52 tones, or using every X tones of the 52 tones.

Additionally, if the wireless device 402-a transmits one or more additional ELR-IDs 420, the wireless device 402-a may utilize a same set of tones across each symbol, utilize a different set of tones across each symbol, or a combination of such tone structures. For example, the wireless device 402-a may transmit the sequence of the ELR-ID 420 via a first set of tones. Accordingly, the wireless device 402-a may transmit the sequence of the ELR-ID 420-b via the first set of tones, a second set of tones different than the first set of tones, or via a subset of the first set of tones. In such implementations, the wireless device 402-a may transmit the sequence of the ELR-ID 420-c via the first set of tones, via the second set of tones, or via a third set of tones different from the first and second set of tones.

In some implementations, because the ELR-IDs 420 are used to indicate that the PPDU 404 is associated with ELR communications, or an ELR mode, the wireless device 402-a may transmit the ELR-ID 420-a via the first set of tones of the first symbol differently from fields of existing PPDU formats at the same location, thereby reducing false alarms at the wireless device 402-b. Thus, the wireless device 402-a may transmit the ELR-IDs via respective symbols using various modulations schemes, tone structures, or the like to distinguish the respective symbols as carrying the ELR-IDs 420.

As an illustrative example, a VHT PPDU may include a VHT-SIG-A1 field after the L-SIG 414, while the PPDU 404 may include the ELR-ID 420-a after the L-SIG 414. Thus, to prevent the wireless device 402-b from misinterpreting the ELR-ID 420-a of the PPDU 404 as the VHT-SIG-A1 field of the VHT PPDU, the wireless device 402-a may transmit the ELR-ID 420-a via the first symbol, where the first symbol is transmitted using a different modulation scheme, different tone structure, or both from the symbol used to transmit the VHT-SIG-A1 field of the VHT PPDU.

As described herein, each of the ELR-IDs 420 may include a respective sequence, such as a set of bits, such that the wireless device 402-b may identify that the PPDU 404 is associated with ELR communications based on the respective sequences. In some implementations, the wireless device 402-a may select the respective sequences for the ELR-IDs 420 to maximize the hamming distance from the RL-SIG 416. For example, if wireless device 402-a transmits the ELR-ID 420-a starting on the second symbol after the L-LTF 412, such as after the L-SIG 414, the wireless device 402-a may set the first N bits of the ELR-ID 420-a to be the inverse, such as opposite, to the first N bits of the encoded L-SIG 41, thereby distinguishing the PPDU 404 from various existing PPDU formats.

In some implementations, the wireless device 402-a may indicate, via the ELR-IDs 420, additional information, such as a BSS ID. For example, each BSS ID may be associated with a different sequence, where a portion of each of the sequences may be orthogonal. Accordingly, if the wireless device 402-a transmits the ELR-ID 420-a after the L-SIG 414 via the first symbol using 48 tones (to carry 48 bits), the wireless device 402-a may determine, based on 5 out of 6 bits of the BSS IDs, one of the 32 bit sequences from an orthogonal mapping, such as the Walsh mapping. Based on determining the 32 bit sequence, the wireless device 402-a may set 32 out of the 48 tones of the first symbol to carry the 32 bit sequence, set 1 or mores tone of the 48 tones in the first symbol to carry the remaining 1 bit for the BSS ID, and set the remaining X tones of the 48 tones to carry X bits of other stationary information.

In some other implementations, the wireless device 402-a may set the sequence of the ELR-ID 420-a to be equal to the sequence of the L-LTF 412. As an illustrative example, if the L-LTF sequence is equal to 0110, the wireless device 402-a may set the sequence of the ELR-ID 420-a equal to 0110. Additionally, or alternatively, the wireless device 402-a may set the sequence of the ELR-ID 420-a to a sequence associated with the U-SIGs 418, such as content of the U-SIGs 18, but with a physical version number that is different than the PHY version number transmitted via the U-SIGs 418 or that is unused. That is, the wireless device 402-a may transmit a first U-SIG sequence with a first PHY version number via the U-SIGs 418 and transmit a second U-SIG sequence with a second physical version number via the ELR-ID 420-a, where the second physical version number is different from the first physical version number or is unused by the transmitted U-SIGs 418. In some implementations, the wireless device 402-a may select the sequence, such as a set of bits, of the ELR-ID, such that the transmission of the ELR-ID 420-a is in accordance with the with a minimal PAPR. That is, the wireless device 402-a may select a sequence of the ELR-ID 420-a such that the PAPR of the transmission may be minimized.

Because the sequences of the ELR-IDs 420 are known at both the wireless device 402-a and the wireless device 402-b, the wireless device 402-b may perform channel estimation boosting on the respective symbols used to transmit the ELR-IDs 420. Accordingly, in such implementations, the wireless device 402-b may monitor for the respective symbols of the ELR-IDs 420 and perform channel estimation boosting, such as channel measurements, using the respective tones and symbols used to transmit the ELR-IDs 420. In some examples, if the wireless device 402-a transmits multiple ELR-IDs 420, where each sequence of the multiple ELR-IDs 420 are the same (repetitions), the wireless devices 402 may perform frequency tracking using the respective tones of the respective symbols.

In this way, by transmitting one or more ELR-IDs 420 via the second portion 408 of the preamble of the PPDU 404, the wireless device may detect and identify that the PPDU 404 is associated with ELR communications without performing multiple hypothesis tests, thereby reducing complexity and latency during ELR communications.

FIG. 5 shows an example of a signaling diagram 500 that illustrates transmission of a PPDU including one or more ELR-IDs following a legacy signal field, where the ELR-IDs indicate the PPDU is associated with ELR communications. Aspects of the signaling diagram 500 may implement aspects of the wireless communication network 100, the PPDU 300, the PPDU 301, the PPDU 303, the PPDU 305, and the signaling diagram 400. For example, the signaling diagram 500 may include a wireless device 502-a and a wireless device 502-b, which may be examples of the wireless device 402-a and the wireless device 402-b as described herein with reference to FIG. 4. The wireless devices 502 may communicate using a PPDU 504, which may be an example of the PPDU 404 as described herein with reference to FIG. 4. The techniques described in the context of the signaling diagram 500 may enable the wireless device 502-a to transmit one or more ELR-IDs 516 after a L-SIG 514 of the PPDU 504, such that the wireless device 502-b may identify that the PPDU 504 is associated with ELR communications according to the one or more ELR-IDs 516.

The PPDU 504 may include a preamble and a data field, where the preamble may include at least a first portion 506 and a second portion 508. The first portion 506 of the preamble may include one or more legacy fields, such as a L-STF 510, a L-LTF 512, and the L-SIG 514, which may correspond to the one or more legacy fields as described herein with reference to FIGS. 2-4. The second portion 508 of the preamble may include the one or more ELR-IDs 516, such as an ELR-ID 516-a, an ELR-ID 516-b, and an ELR-ID 516-c, which may follow the L-SIG 514 of the first portion 506. The ELR-IDs 516 may be examples of the ELR-IDs 420. The PPDU 504 also may include an ELR modulated portion 518, which may be an example of the ELR modulated portion 422. The wireless device 502-a may transmit the one or more ELR-IDs 516 following the L-SIG 514, such that the wireless device 502-b may identify that PPDU 504 is associated with ELR communications relatively quickly and without increasing the complexity at the wireless device 502-b.

In some implementations, to differentiate the PPDU 504 from existing PPDU formats, such as those described herein with reference to FIGS. 2 and 3, the wireless device 502-a may transmit the one or more ELR-IDs 516 according to various modulation schemes, according to various tone structures, with different sequences, or a combination of each. For example, the ELR-ID 516-a may coincide with RL-SIG detection and QBPSK checking at the symbol following the L-SIG 514 in existing PPDU formats. That is, in one or more existing PPDU formats, the field following the L-SIG 514 may be the RL-SIG, VHT-SIG, or HT-SIG, where the HT-SIG may be transmitted according to a QBSK modulation scheme. As such, to avoid the wireless device 502-b interpreting the ELR-ID 516-a as the RL-SIG, VHT-SIG, or HT-SIG, the wireless device 502-a may transmit the ELR-ID 516-a with a different modulation scheme than the modulation schemes used for the RL-SIG, VHT-SIG, or HT-SIG transmission, with a different tone structure than the tone structures used for the RL-SIG, VHT-SIG, or HT-SIG transmission, with a different sequences than the sequence used for the RL-SIG, VHT-SIG, or HT-SIG, or a combination of each.

In such implementations, the wireless device 502-a may determine the modulation scheme, tone structure, and sequence for the transmission of the ELR-ID 516-a according to a legacy data rate defined in L-SIG of the PPDU 504. For example, the modulation scheme, tone structure, or both, used to transmit the second symbol after L-LTF, such as the same location as RL-SIG, in existing PPDU formats may vary based on the legacy data rate of the PPDU. Additionally, the sequence of the second symbol after L-LTF in existing PPDU formats also may vary based on the legacy data rate of the PPDU. As such, to differentiate the ELR-ID 516-a of the PPDU 504 from RL-SIG, VHT-SIG, or HT-SIG of existing PPDU formats, the wireless device 502-a may determine the modulation schemes, the tone structures, or both, of a first set of tones of a first symbol used to transmit the ELR-ID 516-a according to the legacy data rate of the PPDU 504. Similarly, the wireless device 502-a may determine the sequence of the ELR-ID 516-a according to the legacy data rate of the PPDU 504.

In some examples, the legacy data rate of the PPDU 504 may be set to equal to 6 Megabits per second (Mbps). In such examples, the wireless device 502-a may transmit the ELR-ID 516-a according to a BPSK modulation scheme via each tone of the first set of tones. In this way, the wireless device 502-b may differentiate the PPDU 504 from existing PPDU formats, such as the 11n mixed mode (MM) PPDU format. Additionally, or alternatively, to distinguish the RL-SIG field of existing PPDU formats from the ELR-ID 516-a of the PPDU 504, the wireless device 502-a may set the sequence of the ELR-ID 516-a to maximize the hamming distance from the L-SIG 514, for example, by setting the first N bits of the ELR-ID 516-a to be the inverse of the first N bits of the encoded L-SIG 514, thereby ensuring that RL-SIG detection will fail at the wireless device 502-b. That is, the wireless device 502-a may select a sequence of the ELR-ID 516-a such that the sequence is partially inverse to the sequence of the L-SIG 514.

As an illustrative example, the first 4 bits of the L-SIG 514 may correspond to a rate field, while a single bit following the first 4 bits may be a reserved field. Such fields of the L-SIG 514 may be included in any existing MM PPDU formats. In response to block convolution coder (BCC) encoding, the first five bits of the L-SIG 514 may become the first 10 coded bits. Accordingly, the wireless device 502-a may set the part of the sequence of the ELR-ID 516-a to be equal to the 10 coded bits with reversed BPSK modulation, such as BPSK with a 180 degree rotation. That is, the wireless device 502-a may set the part of sequence of the ELR-ID 516-a to be equal to the inverse of the first 10 coded bits of the L-SIG 514, thereby distinguishing the ELR-ID 516-a of the PPDU 504 from the RL-SIG of existing PPDU formats. In such examples, the wireless device 502-a may perform BCC interleaving on the 10 bits of the ELR-ID 516-a, such that the 10 bits of the ELR-ID 516-a are interleaved on the same tones as those of the L-SIG 514. In this way, the hamming distance between the sequence of the ELR-ID 516-a and the RL-SIG may be at least 10, thereby distinguishing the ELR-ID 516-a of the PPDU 504 from the RL-SIG of existing PPDU formats.

In some implementations, if the data rate is equal to 6 Mbps, the wireless device 502-a may further distinguish the ELR-ID 516-a of the PPDU 504 from the RL-SIG, VHT-SIG, or HT-SIG of existing PPDU formats by transmitting the sequence of the ELR-ID 516-a via a subset of the first set of tones of the first symbol and according to the BPSK modulation scheme. For example, the wireless device 502-a may transmit the sequence of the ELR-ID 516-a via the even tones of the first set of tones, the odd tones of the first set of tones, every other tone of the first set of tones, or every X tones of the first set of tones. As such, because the tone structure of the first symbol used to transmit the ELR-ID 516-a is different from the tone structure of a symbol used to transmit the RL-SIG, VHT-SIG, or HT-SIG in existing PPDU formats, the wireless device 502-b may be able to distinguish the ELR-ID 516-a from the RL-SIG, VHT-SIG, or HT-SIG. In such examples, the wireless device 502-a may perform power boosting, such as increasing the transmission power by 3 dB, on the subset of tones used to transmit the sequence of the ELR-ID 516-a.

Additionally, the wireless device 502-a may transmit a field following the ELR-ID 516-a according to the BPSK modulation scheme to avoid triggering 11ac MM detection at the wireless device 502-b. That is, the wireless device 502-a may transmit, via the first symbol, the ELR-ID 516-a according to the BPSK modulation scheme and transmit, via a symbol following the first symbol, the field according to the BPSK modulation scheme.

In some other implementations, the legacy data rate of the PPDU 504 may be set greater than 6 Mbps. Accordingly, the wireless device 502-a may transmit the ELR-ID 516-a via each tone of the first set of tones according to a QBPSK modulation scheme. In such examples, the wireless device 502-a may modulate the symbol following the first symbol according to the BPSK modulation scheme. In this way, legacy receivers (not shown) may decode the PPDU 504 as an 11a PPDU.

By transmitting the sequence of the ELR-ID 516-a via each tone of the first set of tones and according to the QBSK modulation scheme, the wireless devices 502 may distinguish the PPDU 504 from all existing PPDU formats, except for an 11n MM PPDU format. To distinguish the PPDU 504 from the 11n MM PPDU format, thereby avoiding false detections of the 11n MM PPDU format, the wireless device 502-a may transmit the symbol following the first symbol according to a BPSK modulations scheme. In addition to modulating the following symbol according to the BPSK modulation scheme, the wireless device may transmit the ELR-ID 516-a via a subset of the first set of tones, such as by transmitting the ELR-ID 516-a via even tones of the first set of tones or every other tone of the set of tones, and select a different sequence of the ELR-ID 516-a from all possible HT-SIG1 sequences that may be included in 11n MM communications.

In some other implementations, to distinguish between the PPDU 504 and the 11n MM PPDU format, the wireless device 502-a may transmit, via the first symbol, the sequence of the ELR-ID 516-a according to a combination of the BPSK and QBPSK modulation scheme, where first symbol is modulated with the BPSK and QBPSK modulation schemes alternatively on populated tones. In some other implementations, to distinguish between the PPDU 504 and the existing PPDU formats, the wireless device 502-a may transmit the sequence of the ELR-ID 516-a via a subset of the first set of tones, such as by populating every X tone, even tones, or odd tones, and performing power boosting, by 3 dB, the transmission via the subset of the first set of tones. In this way, the wireless device 502-a may transmit the PPDU 504, such that the wireless device 502-b may avoid misinterpreting the PPDU 504 as the existing PPDU formats.

As described herein, the wireless device 502-a may transmit one or more additional ELR-IDs 516 as part of the second portion 508 of the preamble. In such implementations, the wireless device 502-a may transmit the ELR-ID 516-a according to the legacy data rate of the PPDU 504. For example, if the legacy data rate of the PPDU 504 is set to equal to 6 Mbps, the wireless device 502-a may transmit the sequence of the ELR-ID 516-a via each tone of the first set of tones of the first symbol and according to the BPSK modulation. Alternatively, if the legacy data rate of the PPDU 504 is set greater than 6 Mbps, the wireless device 502-a may transmit the sequence of the ELR-ID 516-a via each tone of the first set of tones of the first symbol and according to the QBPSK modulation scheme.

Accordingly, the wireless device 502-a may transmit the sequence of the ELR-ID 516-b via a second set of tones of a second symbol according to a BPSK modulation scheme to distinguish the PPDU 504 from existing PPDU formats, thereby reducing false detections at the wireless device 502-b and increase performance reliability. That is, the wireless device 502-a may change the modulation scheme used for the transmission of the ELR-ID 516-b from the modulation scheme used for transmission of the ELR-ID 516-a to reduce false detections at the wireless device 502-b. In such implementations, the wireless device 502-a may set the sequence of the ELR-ID 516-b to be a repetition of the sequence of the ELR-ID 516-b, such that the wireless device 502-b may perform frequency tracking. That is, the wireless device 502-a may transmit, via a same set of tones of respective symbols and with a same sequence, the ELR-ID 516-a and the ELR-ID 516-b. Alternatively, the wireless device 502-a may set the sequence of the ELR-ID 516-b to a different sequence than the sequence of the ELR-ID 516-a. In some implementations, the wireless device 502-a may set the sequence of the ELR-ID 516-b to be a shifted or interleaved version of the sequence of the ELR-ID 516-a.

As an illustrative example of the modulation schemes used for transmission of the ELR-ID 516-a and the ELR-ID 516-b, if the legacy data rate of the PPDU 504 is set to 6 Mbps, the wireless device 502-a may transmit the ELR-ID 516-a via the first symbol according to the BPSK modulation scheme and transmit the ELR-ID 516-b via the second symbol according to the BPSK modulations scheme. Alternatively, if the legacy data rate of the PPDU 504 is set to be greater than 6 Mbps, the wireless device 502-a may transmit the ELR-ID 516-a via the first symbol according to the QBPSK modulation scheme and transmit the ELR-ID 516-b via the second symbol according to the BPSK. In some implementations, if the legacy data rate of the PPDU 504 is set to be greater than 6 Mbps, the wireless device 502-a may transmit the ELR-ID 516-a and the ELR-ID 516-b via respective symbols according a combination of the BPSK modulation scheme and the QBPSK modulation scheme, such as the BPSK modulation scheme for the first symbol and QBPSK modulation scheme for the second symbol. In some other implementations, if the legacy data rate of the PPDU 504 is set to be greater than 6 Mbps, the wireless device may transmit the ELR-ID 516-a via the first symbol according to the combination of the BPSK modulation scheme and QBPSK modulation scheme and transmit the ELR-ID 516-b via a second symbol according to a combination of the QBPSK modulation scheme and the BPSK modulation scheme, where the ELR-ID 516-a and ELR-ID 516-b are a simple repetition of each other or transmitted with a modulation change.

As an illustrative example of the tone structures for transmission of the ELR-ID 516-a and the ELR-ID 516-b, the wireless device 502-a may transmit the sequence of the ELR-ID 516-a via each tone of the first set of tones of the first symbol and transmit the sequence of the ELR-ID 516-b via each tone of the second set of tones of the second symbol. In such examples, the wireless device 502-a may set the sequence of the ELR-ID 516-b to be equal to the sequence of the ELR-ID 516-a or change the modulation schemes used for each symbol. In some implementations, the wireless device 502-a may transmit the sequence of the ELR-ID 516-a via each tone of the first set of tones and transmit the sequence of the ELR-ID 516-b via a subset of tones of the first set of tones. In such implementations, the wireless device 502-a may set the sequence of the ELR-ID 516-b to be equal to the sequence of the ELR-ID 516-a on the populated tones of the first and second sets of tones. In some implementations, the wireless device 502-a may transmit the sequence of the ELR-ID 516-a via a subset of the first set of tones and transmit the sequence of the ELR-ID 516-b via the subset of the first set of tones, where the sequence of the ELR-ID 516-b is equal to the sequence of the ELR-ID 516-a. In some implementations, the wireless device 502-a may transmit the sequence of the ELR-ID 516-a via a subset of the first set of tones and transmit the sequence of the ELR-ID 516-b via each tone of the first set of tones, where the sequence of the ELR-ID 516-b is equal to the sequence of the ELR-ID 516-a on the populated tones of the first and second sets of tones.

In some implementations, the wireless device 502-a may transmit three ELR-IDs 516. For example, the wireless device 502-a may transmit the ELR-ID 516-a via the first set of tones of the first symbol, transmit the ELR-ID 516-b via the second set of tones of the second symbol, and transmit the ELR-ID 516-c via a third set of tones of a third symbol. In such implementations, the ELR-ID 516-c may be a repetition of the ELR-ID 516-a. That is, the wireless device 502-a may set a sequence of the ELR-ID 516-c to be equal to the sequence of the ELR-ID 516-a and transmit the ELR-ID 516-c via the same tones as the first set of tones, according to the same modulation scheme used for the first symbol, or both.

FIG. 6 shows an example of a signaling diagram 600 that that illustrates transmission of a PPDU including one or more ELR-IDs following a repeat legacy signal field, where the ELR-IDs indicate the PPDU is associated with ELR communications. Aspects of the signaling diagram 600 may implement aspects of the wireless communication network 100, the PDU 200, the PPDU 300, the PPDU 301, the PPDU 303, the PPDU 305, the signaling diagram 400, and the signaling diagram 500 as described herein with reference to FIGS. 1-5. For example, the signaling diagram 600 may include a wireless device 602-a and a wireless device 602-b, which may be examples of corresponding wireless devices as described herein with reference to FIGS. 4 and 5. Additionally, the signaling diagram 600 may include a PPDU 604, which may be an example of a PPDU 404 as described herein with reference to FIG. 4. The techniques described in the context of the signaling diagram 600 may enable the wireless device 602-a to transmit one or more ELR-IDs 618 after a RL-SIG 616 of the PPDU 604, such that the wireless device 602-b may identify that the PPDU 604 is associated with ELR communications according to the one or more ELR-IDs 618.

The PPDU 604 may include a preamble and a data field, where the preamble may include a first portion 606 and a second portion 608. The first portion 606 of the preamble may include one or more fields, such as a L-LTF 610, a L-LTF 612, a L-SIG 614, and the RL-SIG 616, which may be examples of corresponding fields as described herein with reference to FIGS. 2-5. The second portion 608 of the preamble may include the one or more ELR-IDs 618, such as an ELR-ID 618-a, an ELR-ID 618-b, and an ELR-ID 618-c, which may be examples of the one or more ELR-IDs 420 and the one or more ELR-IDs 516 as described herein. The PPDU 604 also may include an ELR modulated portion 620, which may be an example of the ELR modulated portion 422. As described herein, the wireless device 602-a may transmit the one or more ELR-IDs 618 following the RL-SIG 616, such that the wireless device 602-b may identify that PPDU 604 is associated with ELR communications relatively quickly and without increasing the complexity at the wireless device 602-b.

To facilitate the transmission of the one or more ELR-IDs 618 following the transmission of the RL-SIG 616, the wireless device 602-a may transmit the one or more ELR-IDs 618 according to various modulation schemes, according to various tone structures, with various sequences, or a combination of each. For example, using some existing PPDU formats, such as 11ax PPDU formats and later, the wireless device 602-a may modulate a symbol following the RL-SIG 616 according to a BPSK modulation scheme, while using other existing PPDU formats, such as 11n PPDU formats and 11ac, the wireless device 602-a may modulate the symbol according to a QBPSK modulation scheme, where each data tone of the symbol is occupied. Accordingly, to distinguish the PPDU 604 from such existing PPDU formats, the wireless device 602-a may transmit a sequence of the ELR-ID 618-a via a subset of a first set of tones of a first symbol according to a QBPSK modulation scheme, a BPSK modulation scheme, or a combination of both.

In some implementations, to distinguish the PPDU 604 from existing PPDU formats, the wireless device 602-a may transmit the sequence of the ELR-ID 618-a via the first symbol according to the QBPSK modulation scheme. For example, because a majority of existing PPDU formats utilize BPSK modulation for the symbol following the RL-SIG 616, the wireless device 602-a may transmit the sequence of the ELR-ID 618-a via the first symbol, where the first symbol is modulated with the sequence of the ELR-ID 618-a according to the QBPSK modulation scheme, thereby reducing false detection or misinterpretations of the PPDU 604 at the wireless device 602-b.

In some other implementations, to distinguish the PPDU 604 from existing PPDU formats, the wireless device 602-a may transmit the sequence of the ELR-ID 618-a via the first symbol according to a combination of the BPSK and QBPSK modulation scheme alternatively on the populated tones. For example, the wireless device 602-a may modulate a first subset of the first set of tones of the first symbol according to the BPSK modulation scheme and modulate a second subset of the first set of tones according to the QBPSK modulations scheme, thereby modulating the first symbol in an interleaved manner. In such implementations, the wireless device 602-b may reduce misinterpretation, such as false detection, of the PPDU 604 by 3 dB.

In some other implementations, to distinguish the PPDU 604 from existing PPDU formats, the wireless device 602-a may transmit the sequence of the ELR-ID 618-a via a subset of the first set of tones of the first symbol. For example, the wireless device 602-a may transmit the sequence of the ELR-ID 618-a via every X tones of the first set of tones, every other tone of the first set of tones, every even tone of the first set of tones, or every odd tone of the first set of tones. Additionally, the wireless device 602-a may perform power boosting, such as by increasing transmission power by 3 dB, on the subset of the first set of tones, which may reduce misinterpretation, such as false detection, of the PPDU 604 by 3 dB. In such implementations, the wireless device 602-a may transmit the sequence of the ELR-ID 618-a via the subset of the first set of tones of the first symbol according to the QBPSK modulation scheme or the interleaved combination of the QBPSK and BPSK modulation schemes.

In some implementations, to distinguish the PPDU 604 from U-SIG fields of existing PPDU formats, the wireless device 602-a may set a sequence of the ELR-ID 618-a to a U-SIG sequence, such as known U-SIG content, with a physical version number that is different than a PHY version number transmitted via a U-SIG field in the existing PPDU formats or that is unused. Accordingly, the wireless device 602-a may transmit the sequence of the ELR-ID 618-a via each tone of the first set of tones. As such, one or more legacy wireless devices may discard the PPDU 604 based on the physical version number included in the ELR-ID 618-a being unsupported by the one or more legacy wireless devices, different than the PHY version numbers used by the one or more legacy wireless devices, or both.

In some implementations, the wireless device 602-a may transmit respective sequences of two ELR-IDs 618, such as the ELR-ID 618-a and the ELR-ID 618-b, as part of the PPDU 604. In such implementations, the wireless device 602-a may determine various modulation schemes, various tone structures, and various sequences for the two ELR-IDs 618 to distinguish the PPDU 404, with both ELR-IDs 618, from fields of existing PPDU formats, such as repeated HE-SIG-A fields in a HE ER SU PPDU format and U-SIG fields of an ER SU PPDU format.

For example, the wireless device 602-a may transmit the sequence of the ELR-ID 618-a via a subset of the first set of tones of the first symbol and according to the QBPSK modulation scheme. Accordingly, the wireless device 602-a may transmit the sequence of the ELR-ID 618-b via a subset of the second set of tones of a second symbol according to a BPSK modulation scheme to distinguish the PPDU 504 from existing PPDU formats, thereby reducing false detections at the wireless device 502-b and increase performance reliability. That is, the wireless device 602-a may change the modulation scheme used for the transmission of the ELR-ID 618-b from modulation scheme used for the transmission of the ELR-ID 618-a to reduce false detections at the wireless device 602-b.

In some implementations, the wireless device 602-a may set the sequence of the ELR-ID 618-b to be a repetition of the sequence of the ELR-ID 618-b, such that the wireless device 602-b may perform frequency tracking. Alternatively, the wireless device 602-a may set the sequence of the ELR-ID 618-b to a different sequence than the sequence of the ELR-ID 618-a. In some implementations, the wireless device 602-a may set the sequence of the ELR-ID 618-b to be a shifted or interleaved version of the sequence of the ELR-ID 618-a. In some implementations, the wireless device 602-a may set the respective sequences of the ELR-ID 618-a and the ELR-ID 618-b to a sequence associated with a U-SIG field with a PHY version number that is different than a PHY version number transmitted via a U-SIG field in the existing PPDU formats or that is unused. In such implementations, the wireless device 602-a may transmit the sequence of the ELR-ID 618-a via each tone of the first set of tones of the first symbol according to the BPSK modulation scheme and transmit the sequence of the ELR-ID 618-b via each tone of the second set of tones of the second symbol according to the BPSK modulation scheme.

As an illustrative example for the modulation schemes used for transmission of the ELR-IDs 618, the wireless device 602-a may transmit the sequence of the ELR-ID 618-a via the first symbol according to the QBPSK modulation scheme and transmit the sequence of the ELR-ID 618-b via the second symbol according to the BPSK modulation scheme. Alternatively, the wireless device 602-a may transmit the sequence of the ELR-ID 618-a via the first symbol and transmit the sequence of the ELR-ID 618-b via the second symbol according to the QBPSK modulation scheme, where the sequence of the ELR-ID 618-b is equivalent to the sequence of the ELR-ID 618-a. In some implementations, the wireless device 602-a may transmit the sequence of the ELR-ID 618-a via the first symbol and transmit the sequence of the ELR-ID 618-b via the second symbol according to the BPSK modulation scheme, where the respective sequences of the ELR-ID 618-a and the ELR-ID 618-b may be a U-SIG field with an unused or different PHY version number.

In some other implementations, the wireless device 602-a may transmit the sequence of the ELR-ID 618-a via the first symbol according to the BPSK modulation scheme and transmit the sequence of the ELR-ID 618-b via the second symbol according to the QBPSK modulation scheme. In such implementations, the wireless device 602-a may set the respective sequences of the ELR-ID 618-a and the ELR-ID 618-b to a U-SIG field with an unused or different PHY version number. In some implementations, the wireless device 602-a may transmit the sequence of the ELR-ID 618-a via the first symbol and transmit the sequence of the ELR-ID 618-b via the second symbol according to a combination of the BPSK modulation scheme and the QBPSK modulation scheme. In such implementations, the wireless device 602-a may set the sequence of the ELR-ID 618-b to be equivalent to the sequence of the ELR-ID 618-a.

In some other implementations, the wireless device 602-a may transmit the sequence of the ELR-ID 618-a via the first symbol according to a combination of the BPSK modulation scheme and the QBPSK modulation scheme, where the BPSK modulation and QBPSK modulation may be applied alternatively on the populated tones. In such implementations, the wireless device 602-a may transmit the sequence of the ELR-ID 618-b via the second symbol according to a combination of the QBPSK modulation scheme and the BPSK modulation scheme, where the QBPSK modulation and BPSK modulation may be applied alternatively on the populated tones.

As an illustrative example for the tone structures used for transmission of the ELR-IDs 618, the wireless device 602-a may transmit the sequence of the ELR-ID 618-a via every other tone of the first set of tones of the first symbol and transmit the sequence of the ELR-ID 618-b via every other tone of the second set of tones of the second symbol, where the first and second set of tones may be the same. In such implementations, the wireless device 602-a may set the sequence of the ELR-ID 618-b to be equal to the sequence of the ELR-ID 618-a or may transmit each respective sequence of the ELR-IDs 618 according to different modulation schemes. In some other implementations, the wireless device 602-a may transmit the sequence of the ELR-ID 618-a via each tone of the first set of tones of the first symbol and transmit the sequence of the ELR-ID 618-b via each tone of the second set of tones of the second symbol. In such implementations, the wireless device 602-a may set the respective sequences of the ELR-ID 618-a and the ELR-ID 618-b to a U-SIG sequence with an unused or different PHY version number. In some other implementations, the wireless device 602-a may transmit the sequence of the ELR-ID 618-a via even tones of the first set of tones of the first symbol and transmit the sequence of the ELR-ID 618-b via each tone of the first set of tones, where the ELR-ID 618-a and the ELR-ID 618-b use a same sequence on the same set of tones, such as same populated tones

In some implementations, the wireless device 602-a may transmit three ELR-IDs 618. For example, the wireless device 602-a may transmit the sequence of the ELR-ID 618-a via the first set of tones of the first symbol, transmit the sequence of the ELR-ID 618-b via the second set of tones of the second symbol, and transmit a sequence of the ELR-ID 618-c via a third set of tones of a third symbol. In such implementations, the ELR-ID 618-c may be a repetition of the ELR-ID 618-a. That is, the wireless device 602-a may set a sequence of the ELR-ID 618-c to be equal to the sequence of the ELR-ID 618-a and transmit the sequence of the ELR-ID 618-c via the same tones as the first set of tones, according to the same modulation scheme used for the first symbol, or both.

FIG. 7 shows an example of a signaling diagram 700 that illustrates transmission of a PPDU including one or more ELR-IDs following one or more universal signal fields, where the ELR-IDs indicate the PPDU is associated with ELR communications. Aspects of the signaling diagram 700 may implement aspects of the wireless communication network 100, the PDU 200 the PPDU 300, the PPDU 301, the PPDU 303, the PPDU 305, the signaling diagram 400, the signaling diagram 500, and the signaling diagram 600 as described herein with reference to FIGS. 1-6. For example, the signaling diagram 700 may include a wireless device 702-a and a wireless device 702-b, which may be examples of corresponding wireless devices as described herein with reference to FIGS. 4-6. Additionally, the signaling diagram 700 may include a PPDU 704, which may be an example of a PPDU 404 as described herein with reference to FIG. 4. The techniques described in the context of the signaling diagram 700 may enable the wireless device 702-a to transmit one or more ELR-IDs 720 after U-SIGs 718 of the PPDU 704, such that the wireless device 702-b may identify that the PPDU 704 is associated with ELR communications according to the one or more ELR-IDs 720.

The PPDU 704 may include a preamble and a data field, where the preamble may include a first portion 706 and a second portion 708. The first portion 706 of the preamble may include one or more fields, such as a L-LTF 710, a L-LTF 712, a L-SIG 714, the RL-SIG 716, a U-SIG 718-a, and a U-SIG 718-b, which may be examples of corresponding fields as described herein with reference to FIGS. 2-6. The second portion 708 of the preamble may include the one or more ELR-IDs 720, such as an ELR-ID 720-a, an ELR-ID 720-b, and an ELR-ID 720-c, which may be examples of the one or more ELR-IDs 420, the one or more ELR-IDs 516, and the one or more ELR-IDs 618 as described herein. The PPDU 704 also may include an ELR modulated portion 722, which may be an example of the ELR modulated portion 422. As described herein, the wireless device 702-a may transmit the one or more ELR-IDs 720 following the U-SIGs 718, such that the wireless device 702-b may identify that PPDU 704 is associated with ELR communications relatively quickly and without increasing the complexity at the wireless device 702-b.

To facilitate the transmission of the one or more ELR-IDs 720 following the transmission of the U-SIGs 718, the wireless device 702-a may transmit the one or more ELR-IDs 720 according to various modulation schemes, according to various tone structures, with various sequences, or a combination of each. For example, the symbol following the U-SIG 718-b, such as the fifth symbol after the L-LTF 712, may be an ER SU SIG field transmitted according to a random BPSK modulation scheme as in 11ax or 11be ER SU PPDU formats, may be random SIG fields transmitted according to variable modulation schemes as in MU PPDU formats, may be an STF as in TB PPDU formats, or may be a LTF as in 11n MM or 11ac PPDU formats. In such formats, legacy mode detection may be completed by the reception of the symbol following the U-SIG 718-b.

In some implementations, the wireless device 702-a may set a sequence of the ELR-ID 720-a to be any sequence known by the wireless device 702-a and the wireless device 702-b with a phase rotation, such as a 90 or 180 degree phase rotation. Alternatively, the wireless device 702-a may set the sequence of the ELR-ID 720-a to be equal to a sequence of the L-LTF 712. As such, by setting the sequence of the ELR-ID 720-a to a previously used or pre-defined, such as known, sequence, the wireless devices 702 may perform channel estimation boosting using the first set of tones and the first symbol.

Accordingly, to distinguish the PPDU 704 from existing PPDU formats, the wireless device 702-a may transmit the sequence of the ELR-ID 720-a via a first set of tones of a first symbol according to a combination of the BPSK and QBPSK modulation scheme. For example, the wireless device 702-a may modulate a first subset of the first set of tones of the first symbol according to the BPSK modulation scheme and modulate a second subset of the first set of tones according to the QBPSK modulations scheme, thereby modulating the first symbol in an interleaved manner. Additionally, or alternatively, the wireless device 702-a may transmit the sequence of the ELR-ID 720-a via a subset of the first set of tones, for example, by transmitting the sequence of the ELR-ID 720-a via every X tones of the first set of tones, via the even tones of the first set of tones, via the odd tones of the set of tones, via every other tone of the first set of tones. In such implementations, the wireless device 702-a may perform power boosting, such as by increasing transmission power by 3 dB, on the subset of the first set of tones, thereby reducing false detection at the wireless device 702-b by 3 dB.

In some implementations, the wireless device 702-a may transmit respective sequences of two ELR-IDs 720, such as the ELR-ID 720-a and the ELR-ID 720-b, as part of the PPDU 704. The wireless device 702-a may set the sequence of the ELR-ID 720 a to be any known sequence or sequence used in L-LTF 712 of the preamble with a phase rotation. In such implementations, the wireless device 702-a may transmit the sequence of the ELR-ID 720-a via a subset of the first set of tones, according to a combination of the BPSK and QBPSK modulation scheme, or both. In such implementations, the wireless device 702-a may transmit the ELR-ID 720-b via a second set of tones of a second symbol or via a subset of the second set of tones of the second symbol, where the second set of tones may be the same as the first set of tones or different than the first set of tones. Additionally, the wireless device 702-a may set the sequence of the ELR-ID 720-b to be equal to the sequence of the ELR-ID 720-a. Alternatively, wireless device 702-a may set the sequence of the ELR-ID 720-b to a different sequence, a shifted sequence, or an interleaved sequence of the sequence of the ELR-ID 720-a.

In some implementations, the wireless device 702-a may transmit three ELR-IDs 720. For example, the wireless device 702-a may transmit the sequence of the ELR-ID 720-a via the first set of tones of the first symbol, transmit the sequence of the ELR-ID 720-b via the second set of tones of the second symbol, and transmit a sequence of the ELR-ID 720-c via a third set of tones of a third symbol. In such implementations, the ELR-ID 720-c may be a repetition of the ELR-ID 720-a. That is, the wireless device 702-a may set a sequence of the ELR-ID 720-c to be equal to the sequence of the ELR-ID 720-a and transmit the ELR-ID 720-c via the same tones as the first set of tones, according to the same modulation scheme used for the first symbol, or both.

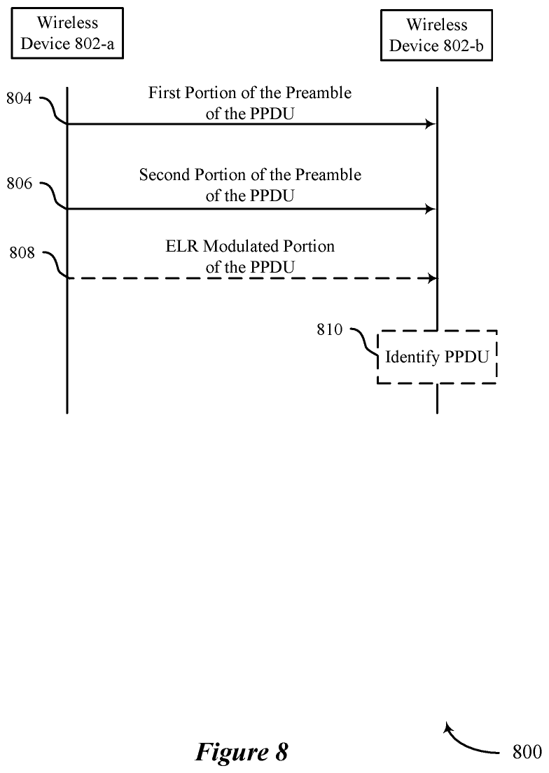

FIG. 8 shows an example of a process flow that illustrates transmission of a PPDU a first portion and a second portion, where the second portion includes one or more ELR-IDs indicating that the PPDU is associated with ELR communications. Aspects of the process flow 800 may implement, or be implemented by, aspects of the wireless communication network 100, the PDU 200, the PPDU 300, the PPDU 301, the PPDU 303, the PPDU 305, the signaling diagram 400, the signaling diagram 500, the signaling diagram 600, and the signaling diagram 700, as described herein with reference to FIGS. 1-7. For example, the process flow 800 may include a wireless device 802-a and a wireless device 802-b, which may be examples of the wireless devices described with reference to FIGS. 4-7. The techniques described in the context of the process flow 800 may enable the wireless device 802-a to transmit an ELR signature field via a PPDU, such that the wireless device 802-b may identify that the PPDU is associated with ELR communications.

At 804, the wireless device 802-a may transmit a first portion of a preamble of a PPDU. For example, the wireless device 802-a may transmit the first portion of the preamble, where the first portion of the preamble includes an L-STF field, an L-LTF field, and an L-SIG field as described herein with reference to FIG. 5. In some implementations, the wireless device 802-a may transmit the first portion of the preamble, where the first portion of the preamble includes an L-STF field, an L-LTF field, an L-SIG field, and an RL-SIG as described herein with reference to FIG. 6. In some other implementations, the wireless device 802-a may transmit the first portion of the preamble, where the first portion includes an L-STF field, an L-LTF field, an L-SIG field, an RL-SIG, and one or more U-SIGs as described herein with reference to FIG. 7.

At 806, in response to transmitting the first portion of the preamble, the wireless device 802-a may transmit a second portion, where the second portion of the preamble includes at least a first ELR signature field, such as the ELR-ID1, indicating that the PPDU is associated with, such as is intended for, ELR communications. In some implementations, the wireless device 802-a may transmit the first ELR signature field following the L-SIG of the first portion of the preamble, such that the wireless device 802-b receives the L-SIG prior to receiving the first ELR signature field as described herein with reference to FIG. 5. In some other implementations, the wireless device 802-a may transmit the first ELR signature field following the RL-SIG of the first portion of the preamble, such that the wireless device 802-b receives the RL-SIG prior to receiving the first ELR signature field as described herein with reference to FIG. 6. In some other implementations, the wireless device 802-a may transmit the first ELR signature field following the one or more U-SIGs of the first portion of the preamble, such that the wireless device 802-b receives the one or more U-SIGs prior to receiving the first ELR signature field as described herein with reference to FIG. 7. In some implementations, the wireless device 802-a may transmit one or more additional ELR signature fields, such as a second ELR signature field or a third ELR signature field, as described herein with reference to FIGS. 4-7.

Additionally, or alternatively, the wireless device 802-a may select, or otherwise identify, a sequence, such as a set of bits, of the first ELR signature field. For example, the wireless device 802-a may set the sequence of the first ELR signature field to be partially inverse, such as the opposite, of a sequence of the L-SIG field. In some implementations, the wireless device 802-a may indicate a BSS ID, such as the BSS color, associated with the ELR communications via the first ELR signature field. The wireless device 802-a may set the sequence of the first ELR signature field to be equivalent to a sequence of the L-LTF of the first portion of the preamble, to include a sequence associated with a U-SIG field with a PHY version number associated with the ELR communications, in accordance with minimizing a PAPR of the first symbol used to carry first the ELR signature in the time domain, or a combination of each.

At 808, the wireless device 802-b may transmit an ELR modulated portion of the PPDU, such as the ELR modulated portion 422, which may include zero, one, or more ELR-STFs, zero, one, or more ELR-LTFs, one or more ELR-SIGs, ELR Data, or a combination of such fields. At 810, in response to receiving the second portion of the preamble of the PPDU, the wireless device 802-b may identify that the PPDU is associated with, such as intended for, ELR communications in accordance with the first sequence of the first ELR signature field being included in the preamble of the ELR PPDU. Accordingly, the wireless device 802-b may decode and obtain the data associated with the ELR PPDU according to the identification.

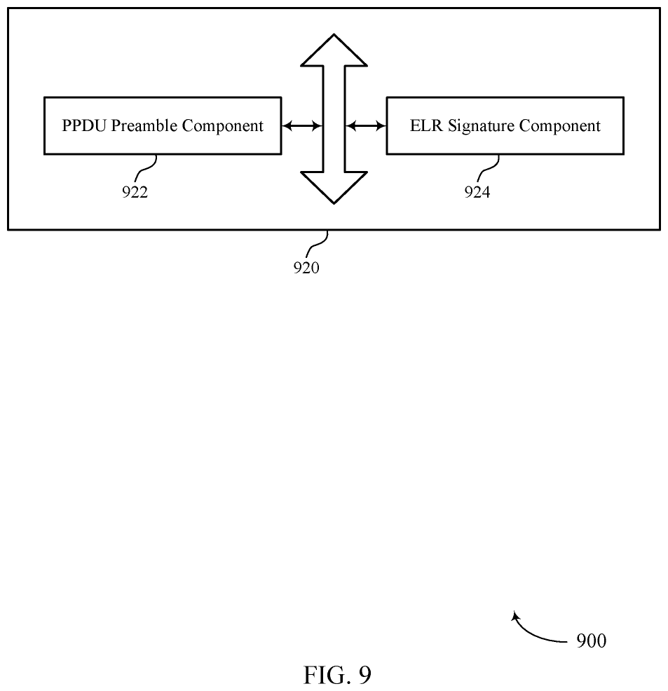

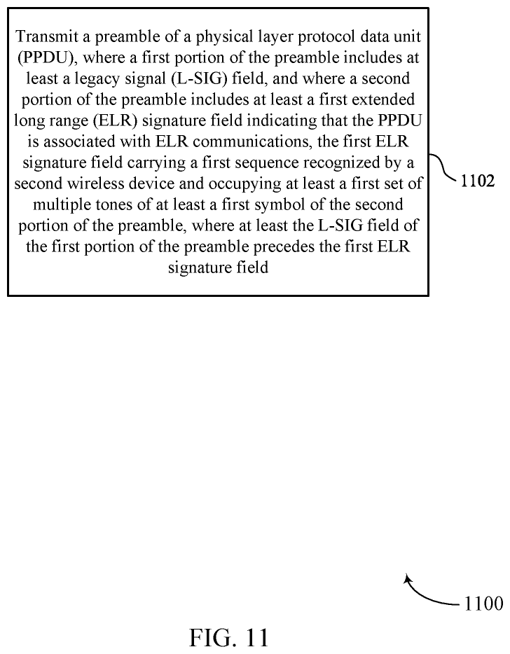

FIG. 9 shows a block diagram of an example wireless communication device 920 that supports ELR PPDU design by implementation of one or more components within the wireless communication device. In some examples, the wireless communication device 920 is configured to perform the process 1100 described with reference to FIG. 11. The wireless communication device 920 may include one or more chips, SoCs, chipsets, packages, components or devices that individually or collectively constitute or include a processing system. The processing system may interface with other components of the wireless communication device 920, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 920 may transmit the information output from the chip. In such an example, the second interface may refer to an interface between the processing system of the chip and a reception component, such that the wireless communication device 920 may receive information that is then passed to the processing system. In some such examples, the first interface also may obtain information, such as from the transmission component, and the second interface also may output information, such as to the reception component.

The processing system of the wireless communication device 920 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

In some examples, the wireless communication device 920 can be configurable or configured for use in an AP, such as the AP 102 described with reference to FIG. 1. In some other examples, the wireless communication device 920 can be an AP that includes such a processing system and other components including multiple antennas. The wireless communication device 920 is capable of transmitting and receiving wireless communications in the form of, for example, wireless packets. For example, the wireless communication device 920 can be configurable or configured to transmit and receive packets in the form of physical layer PPDUs and MPDUs conforming to one or more of the IEEE 802.11 family of wireless communication protocol standards. In some other examples, the wireless communication device 920 can be configurable or configured to transmit and receive signals and communications conforming to one or more 3GPP specifications including those for 5G NR or 6G. In some examples, the wireless communication device 920 also includes or can be coupled with one or more application processors which may be further coupled with one or more other memories. In some examples, the wireless communication device 920 further includes at least one external network interface coupled with the processing system that enables communication with a core network or backhaul network that enables the wireless communication device 920 to gain access to external networks including the Internet.

The wireless communication device 920 includes a PPDU preamble component 922 and an ELR signature component 924. Portions of one or more of the PPDU preamble component 922 and the ELR signature component 924 may be implemented at least in part in hardware or firmware. For example, one or more of the PPDU preamble component 922 and the ELR signature component 924 may be implemented at least in part by at least a processor or a modem. In some examples, portions of one or more of the PPDU preamble component 922 and the ELR signature component 924 may be implemented at least in part by a processor and software in the form of processor-executable code stored in memory.

The wireless communication device 920 may support wireless communications in accordance with examples as disclosed herein. The PPDU preamble component 922 is configurable or configured to transmit a preamble of a PPDU, where the first portion of the preamble includes at least a L-SIG field. The ELR signature component 924 is configurable or configured to include, in a second portion of the preamble, at least a first ELR signature field indicating that the PPDU is associated with ELR communications, the first ELR signature field carrying a first sequence recognized by a second wireless device and occupying at least a first set of multiple tones of at least a first symbol of the second portion of the preamble, where at least the L-SIG field of the first portion of the preamble precedes the first ELR signature field.

In some examples, the ELR signature component 924 is configurable or configured to include, in the second portion of the preamble, a second ELR signature field carrying a second sequence recognized by the second wireless device and occupying a second set of multiple tones of a second symbol of the second portion of the preamble, the first ELR signature field preceding the second ELR signature field in the second portion of the preamble.

In some examples, the first sequence of the first ELR signature field is equivalent to the second sequence of the second ELR signature field.

In some examples, the second sequence of the second ELR signature field is different from the first sequence of the first ELR signature field.

In some examples, the second set of multiple tones is different from the first set of multiple tones.

In some examples, the second set of multiple tones is the same as the first set of multiple tones.

In some examples, the first ELR signature field is transmitted according to a first modulation scheme, and the second ELR signature field is transmitted according to a second modulation scheme.

In some examples, the first ELR signature field and the second ELR signature field are transmitted according to a same modulation scheme.

In some examples, the ELR signature component 924 is configurable or configured to include, in the second portion of the preamble, a third ELR signature field carrying a third sequence recognized by the second wireless device and occupying a third set of multiple tones of a third symbol of the second portion of the preamble, the second ELR signature field preceding the third ELR signature field in the second portion of the preamble.

In some examples, the third sequence of the third ELR signature field is a repetition of the first sequence of the first ELR signature field.

In some examples, the first ELR signature field occupies a subset of the first set of multiple tones.

In some examples, the first portion of the preamble of the PPDU further includes a RL-SIG field, and the RL-SIG field of the first portion of the preamble precedes the first ELR signature field.

In some examples, the first portion of the preamble of the PPDU includes one or more U-SIG fields, and the one or more U-SIG fields of the first portion of the preamble precede the first ELR signature field.

In some examples, the first sequence of the first ELR signature field is transmitted according to a modulation scheme that is in accordance with a BPSK modulation associated with a phase rotation.

In some examples, the modulation scheme includes one of a BPSK modulation scheme, a QBSK modulation scheme, a reversed BPSK modulations scheme, a combination of the BPSK modulation scheme and the QBPSK modulation scheme, a combination of the BPSK modulation scheme and the reversed BPSK modulation scheme.

In some examples, the first ELR signature field is partially inverse to the L-SIG field.

In some examples, the first ELR signature field further indicates a basic service set identifier associated with the ELR communications.

In some examples, the first ELR signature field is equivalent to a L-LTF included in the first portion of the preamble of the PPDU.

In some examples, the first sequence of the first ELR signature field includes a sequence associated with a U-SIG field with a physical version number associated with the ELR communications.

In some examples, the first sequence of the first ELR signature field is selected in accordance with a PAPR associated with the ELR communications.

In some examples, channel estimation boosting of a channel between the wireless device and a second wireless device are measured in accordance with the first set of multiple tones of the first symbol used to transmit the first ELR signature field.

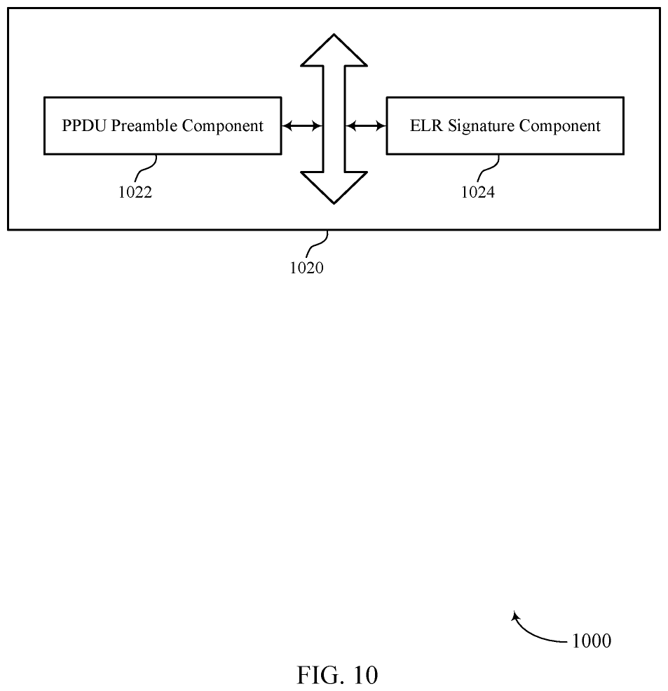

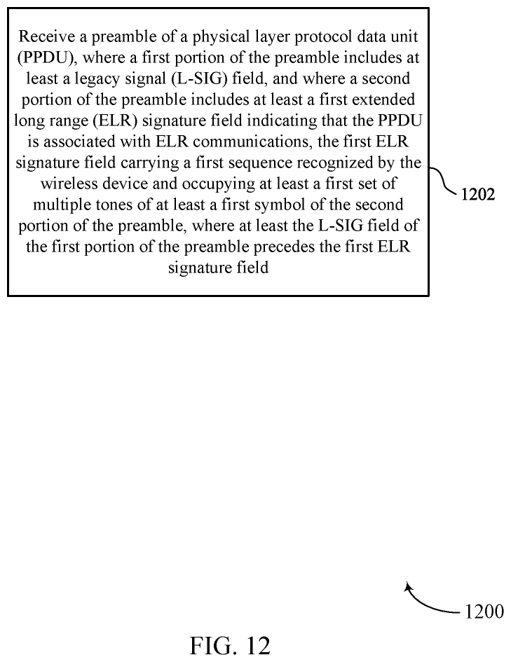

FIG. 10 shows a block diagram of an example wireless communication device 1020 that supports ELR PPDU design by implementation of one or more components within the wireless communication device. In some examples, the wireless communication device 1020 is configured to perform the process 1200 described with reference to FIG. 12. The wireless communication device 1020 may include one or more chips, SoCs, chipsets, packages, components or devices that individually or collectively constitute or include a processing system. The processing system may interface with other components of the wireless communication device 1020, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1020 may transmit the information output from the chip. In such an example, the second interface may refer to an interface between the processing system of the chip and a reception component, such that the wireless communication device 1020 may receive information that is then passed to the processing system. In some such examples, the first interface also may obtain information, such as from the transmission component, and the second interface also may output information, such as to the reception component.

The processing system of the wireless communication device 1020 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

In some examples, the wireless communication device 1020 can be configurable or configured for use in a STA, such as the STA 104 described with reference to FIG. 1. In some other examples, the wireless communication device 1020 can be a STA that includes such a processing system and other components including multiple antennas. The wireless communication device 1020 is capable of transmitting and receiving wireless communications in the form of, for example, wireless packets. For example, the wireless communication device 1020 can be configurable or configured to transmit and receive packets in the form of physical layer PPDUs and MPDUs conforming to one or more of the IEEE 802.11 family of wireless communication protocol standards. In some other examples, the wireless communication device 1020 can be configurable or configured to transmit and receive signals and communications conforming to one or more 3GPP specifications including those for 5G NR or 6G. In some examples, the wireless communication device 1020 also includes or can be coupled with one or more application processors which may be further coupled with one or more other memories. In some examples, the wireless communication device 1020 further includes a user interface (UI) (such as a touchscreen or keypad) and a display, which may be integrated with the UI to form a touchscreen display that is coupled with the processing system. In some examples, the wireless communication device 1020 may further include one or more sensors such as, for example, one or more inertial sensors, accelerometers, temperature sensors, pressure sensors, or altitude sensors, that are coupled with the processing system.

The wireless communication device 1020 includes a PPDU preamble component 1022 and an ELR signature component 1024. Portions of one or more of the PPDU preamble component 1022 and the ELR signature component 1024 may be implemented at least in part in hardware or firmware. For example, one or more of the PPDU preamble component 1022 and the ELR signature component 1024 may be implemented at least in part by at least a processor or a modem. In some examples, portions of one or more of the PPDU preamble component 1022 and the ELR signature component 1024 may be implemented at least in part by a processor and software in the form of processor-executable code stored in memory.

The wireless communication device 1020 may support wireless communications in accordance with examples as disclosed herein. The PPDU preamble component 1022 is configurable or configured to receive a preamble of a PPDU, where a first portion of the preamble includes at least a L-SIG field. The ELR signature component 1024 is configurable or configured to include, in a second portion of the preamble, at least a first ELR signature field indicating that the PPDU is associated with ELR communications, the first ELR signature field carrying a first sequence recognized by the wireless device and occupying at least a first set of multiple tones of at least a first symbol of the second portion of the preamble, where at least the L-SIG field of the first portion of the preamble precedes the first ELR signature field.

In some examples, the ELR signature component 1024 is configurable or configured to include, in the second portion of the preamble, a second ELR signature field carrying a second sequence recognized by the wireless device and occupying a second set of multiple tones of a second symbol of the second portion of the preamble, the first ELR signature field preceding the second ELR signature field in the second portion of the preamble.

In some examples, the first sequence of the first ELR signature field is equivalent to the second sequence of the second ELR signature field.

In some examples, the second sequence of the second ELR signature field is different from the first sequence of the first ELR signature field.

In some examples, the second set of multiple tones is different from the first set of multiple tones.

In some examples, the second set of multiple tones is the same as the first set of multiple tones.

In some examples, the first ELR signature field is received according to a first modulation scheme, and the second ELR signature field is received according to a second modulation scheme.

In some examples, the first ELR signature field and the second ELR signature field are received according to a same modulation scheme.

In some examples, the ELR signature component 1024 is configurable or configured to include, in the second portion of the preamble, a third ELR signature field carrying a third sequence recognized by the wireless device and occupying a third set of multiple tones of a third symbol of the second portion of the preamble, the second ELR signature field preceding the third ELR signature field in the second portion of the preamble.

In some examples, the third sequence of the third ELR signature field is a repetition of the first sequence of the first ELR signature field.

In some examples, the ELR signature component 1024 the first ELR signature field occupies a subset of the first set of multiple tones.

In some examples, the first portion of the preamble of the PPDU further includes a RL-SIG field, and the RL-SIG field of the first portion of the preamble precedes the first ELR signature field.

In some examples, the first portion of the preamble of the PPDU includes one or more U-SIG fields, and the one or more U-SIG fields of the first portion of the preamble precede the first ELR signature field.

In some examples, the first ELR signature field is received according to a modulation scheme that is in accordance with a BPSK modulation scheme with a phase rotation.

In some examples, the modulation scheme includes one of a BPSK modulation scheme, a QBSK modulation scheme, a reversed BPSK modulations scheme, a combination of the BPSK modulation scheme and the QBPSK modulation scheme, a combination of the BPSK modulation scheme and the reversed BPSK modulation scheme.

In some examples, the first sequence of the first ELR signature field is partially inverse to the L-SIG field.

In some examples, the first sequence of the first ELR signature field further indicates a basic service set identifier associated with the ELR communications.

In some examples, the first sequence of the first ELR signature field is equivalent to a legacy long training field (LTF) included in the first portion of the preamble of the PPDU.

In some examples, the first sequence of the first ELR signature field includes a sequence associated with a U-SIG field with a physical version number associated with the ELR communications.

In some examples, the first ELR signature field is selected in accordance with a peak to average power ratio (PAPR) associated with the ELR communications.

In some examples, the ELR signature component 1024 is configurable or configured to perform channel estimation boosting of a channel between the wireless device and a second wireless device using the first set of multiple tones of the first symbol.

FIG. 11 shows a flowchart illustrating an example process 1100 performable by or at a wireless device that supports ELR PPDU design by implementation of one or more components within the wireless communication device. The operations of the process 1100 may be implemented by a wireless device or its components as described herein. For example, the process 1100 may be performed by a wireless communication device, such as the wireless communication device 900 described with reference to FIG. 9, operating as or within a wireless AP. In some examples, the process 1100 may be performed by a wireless AP, such as one of the APs 102 described with reference to FIG. 1.

In some examples, in 1102, the wireless device may transmit a preamble of a PPDU, where a first portion of the preamble includes at least a L-SIG field, and where a second portion of the preamble includes at least a first ELR signature field indicating that the PPDU is associated with ELR communications, the first ELR signature field carrying a first sequence recognized by a second wireless device and occupying at least a first set of multiple tones of at least a first symbol of the second portion of the preamble, where at least the L-SIG field of the first portion of the preamble precedes the first ELR signature field. The operations of 1102 may be performed in accordance with examples as disclosed herein. In some implementations, aspects of the operations of 1102 may be performed by a PPDU preamble component 922 as described with reference to FIG. 9.

FIG. 12 shows a flowchart illustrating an example process 1200 performable by or at a wireless device that supports ELR PPDU design. The operations of the process 1200 may be implemented by a wireless device or its components as described herein. For example, the process 1200 may be performed by a wireless communication device, such as the wireless communication device 1000 described with reference to FIG. 10, operating as or within a wireless STA. In some examples, the process 1200 may be performed by a wireless STA, such as one of the STAs 104 described with reference to FIG. 1.

In some examples, in 1202, the wireless device may receive a preamble of a PPDU, where the first portion of the preamble includes at least a L-SIG field, and where a second portion of the preamble includes at least a first ELR signature field indicating that the PPDU is associated with ELR communications, the first ELR signature field carrying a first sequence recognized by a second wireless device and occupying at least a first set of multiple tones of at least a first symbol of the second portion of the preamble, where at least the L-SIG field of the first portion of the preamble precedes the first ELR signature field. The operations of 1202 may be performed in accordance with examples as disclosed herein. In some implementations, aspects of the operations of 1202 may be performed by a PPDU preamble component 1022 as described with reference to FIG. 10.

Implementation examples are described in the following numbered clauses:

Aspect 1: A method for wireless communications at a first wireless device, comprising: transmitting a preamble of a PPDU, wherein a first portion of the preamble comprises at least a L-SIG field, and wherein a second portion of the preamble comprises at least a first ELR signature field indicating that the PPDU is associated with ELR communications, the first ELR signature field carrying a first sequence recognized by a second wireless device and occupying at least a first plurality of tones of at least a first symbol of the second portion of the preamble, wherein at least the L-SIG field of the first portion of the preamble precedes the first ELR signature field.

Aspect 2: The method of aspect 1, wherein the second portion of the preamble further comprises a second ELR signature field carrying a second sequence recognized by the second wireless device and occupying a second plurality of tones of a second symbol of the second portion of the preamble, the first ELR signature field preceding the second ELR signature field in the second portion of the preamble.

Aspect 3: The method of aspect 2, wherein the first sequence of the first ELR signature field is equivalent to the second sequence of the second ELR signature field.

Aspect 4: The method of aspect 2, wherein the second sequence of the second ELR signature field is different from the first sequence of the first ELR signature field.

Aspect 5: The method of any of aspects 2 through 4, wherein the second plurality of tones is different from the first plurality of tones.

Aspect 6: The method of any of aspects 2 through 4, wherein the second plurality of tones is the same as the first plurality of tones.

Aspect 7: The method of any of aspects 2 through 6, wherein the first ELR signature field is transmitted according to a first modulation scheme, and the second ELR signature field is transmitted according to a second modulation scheme.

Aspect 8: The method of any of aspects 2 through 6, wherein the first ELR signature field and the second ELR signature field are transmitted according to a same modulation scheme.

Aspect 9: The method of any of aspects 2 through 8, wherein the second portion of the preamble further comprises a third ELR signature field carrying a third sequence recognized by the second wireless device and occupying a third plurality of tones of a third symbol of the second portion of the preamble, the second ELR signature field preceding the third ELR signature field in the second portion of the preamble.

Aspect 10: The method of aspect 9, wherein the third sequence of the third ELR signature field is a repetition of the first sequence of the first ELR signature field.

Aspect 11: The method of any of aspects 1 through 10, wherein the first ELR signature field occupies a subset of the first plurality of tones.

Aspect 12: The method of any of aspects 1 through 11, wherein the first portion of the preamble of the PPDU further includes a RL-SIG field, and the RL-SIG field of the first portion of the preamble precedes the first ELR signature field.

Aspect 13: The method of any of aspects 1 through 11, wherein the first portion of the preamble of the PPDU includes one or more U-SIG fields, and the one or more U-SIG fields of the first portion of the preamble precede the first ELR signature field.

Aspect 14: The method of any of aspects 1 through 13, wherein the first sequence of the first ELR signature field is transmitted according to a modulation scheme that is in accordance with a BPSK modulation associated with a phase rotation.

Aspect 15: The method of aspect 14, wherein the modulation scheme comprises one of the BPSK modulation scheme, a QBPSK modulation scheme, a reversed BPSK modulations scheme, a combination of the BPSK modulation scheme and the QBPSK modulation scheme, a combination of the BPSK modulation scheme and the reversed BPSK modulation scheme.

Aspect 16: The method of any of aspects 1 through 15, wherein the first ELR signature field is partially inverse to the L-SIG field.

Aspect 17: The method of any of aspects 1 through 15, wherein the first ELR signature field further indicates a basic service set identifier associated with the ELR communications.

Aspect 18: The method of any of aspects 1 through 15, wherein the first ELR signature field is equivalent to a L-LTF field included in the first portion of the preamble of the PPDU.

Aspect 19: The method of any of aspects 1 through 15, wherein the first sequence of the first ELR signature field comprises a sequence associated with a U-SIG field with a physical version number associated with the ELR communications.

Aspect 20: The method of any of aspects 1 through 19, wherein the first sequence of the first ELR signature field is selected in accordance with a PAPR associated with the ELR communications.

Aspect 21: The method of any of aspects 1 through 20, wherein channel estimation of a channel between the first wireless device and the second wireless device are measured in accordance with the first plurality of tones of the first symbol used to transmit the first ELR signature field.

Aspect 22: A method for wireless communications at a wireless device, comprising: receiving a preamble of a PPDU, wherein a first portion of the preamble comprises at least a L-SIG field, and wherein a second portion of the preamble comprises at least a first ELR signature field indicating that the PPDU is associated with ELR communications, the first ELR signature field carrying a first sequence recognized by the wireless device and occupying at least a first plurality of tones of at least a first symbol of the second portion of the preamble, wherein at least the L-SIG field of the first portion of the preamble precedes the first ELR signature field.

Aspect 23: The method of aspect 22, wherein the second portion of the preamble comprises a second ELR signature field carrying a second sequence recognized by the wireless device and occupying a second plurality of tones of a second symbol of the second portion of the preamble, the first ELR signature field preceding the second ELR signature field in the second portion of the preamble.

Aspect 24: The method of aspect 23, wherein the first sequence of the first ELR signature field is equivalent to the second sequence of the second ELR signature field.

Aspect 25: The method of aspect 23, wherein the second sequence of the second ELR signature field is different from the first sequence of the first ELR signature field.

Aspect 26: The method of any of aspects 23 through 25, wherein the second plurality of tones is different from the first plurality of tones.

Aspect 27: The method of any of aspects 23 through 25, wherein the second plurality of tones is the same as the first plurality of tones.

Aspect 28: The method of any of aspects 23 through 27, wherein the first ELR signature field is received according to a first modulation scheme, and the second ELR signature field is received according to a second modulation scheme.

Aspect 29: The method of any of aspects 23 through 27, wherein the first ELR signature field and the second ELR signature field are received according to a same modulation scheme.

Aspect 30: The method of any of aspects 23 through 29, wherein the second portion of the preamble comprises a third ELR signature field carrying a third sequence recognized by the wireless device and occupying a third plurality of tones of a third symbol of the second portion of the preamble, the second ELR signature field preceding the third ELR signature field in the second portion of the preamble.

Aspect 31: The method of aspect 30, wherein the third sequence of the third ELR signature field is a repetition of the first sequence of the first ELR signature field.

Aspect 32: The method of any of aspects 22 through 31, wherein the first ELR signature field occupies a subset of the first plurality of tones.

Aspect 33: The method of any of aspects 22 through 32, wherein the first portion of the preamble of the PPDU further includes a RL-SIG field, and the RL-SIG field of the first portion of the preamble precedes the first ELR signature field.

Aspect 34: The method of any of aspects 22 through 32, wherein the first portion of the preamble of the PPDU includes one or more U-SIG fields, and the one or more U-SIG fields of the first portion of the preamble precede the first ELR signature field.

Aspect 35: The method of any of aspects 22 through 34, wherein the first ELR signature field is received according to a modulation scheme that is in accordance with a BPSK modulation scheme with a phase rotation.

Aspect 36: The method of aspect 35, wherein the modulation scheme comprises one of the BPSK modulation scheme, a QBPSK modulation scheme, a reversed BPSK modulations scheme, a combination of the BPSK modulation scheme and the QBPSK modulation scheme, a combination of the BPSK modulation scheme and the reversed BPSK modulation scheme.

Aspect 37: The method of any of aspects 22 through 36, wherein the first sequence of the first ELR signature field is partially inverse to the L-SIG field.

Aspect 38: The method of any of aspects 22 through 36, wherein the first sequence of the first ELR signature field further indicates a basic service set identifier associated with the ELR communications.

Aspect 39: The method of any of aspects 22 through 36, wherein the first sequence of the first ELR signature field is equivalent to a legacy long training field (LTF) included in the first portion of the preamble of the PPDU.

Aspect 40: The method of any of aspects 22 through 36, wherein the first sequence of the first ELR signature field comprises a sequence associated with a U-SIG field with a physical version number associated with the ELR communications.

Aspect 41: The method of any of aspects 22 through 40, wherein the first ELR signature field is selected in accordance with a PAPR associated with the ELR communications.

Aspect 42: The method of any of aspects 22 through 41, further comprising: performing channel estimation of a channel between the wireless device and a second wireless device using the first plurality of tones of the first symbol.

Aspect 43: A first wireless device for wireless communications, comprising one or more memories storing processor-executable code, and one or more processors coupled with the one or more memories and individually or collectively operable to execute the code to cause the first wireless device to perform a method of any of aspects 1 through 21.

Aspect 44: A first wireless device for wireless communications, comprising at least one means for performing a method of any of aspects 1 through 21.

Aspect 45: A non-transitory computer-readable medium storing code for wireless communications, the code comprising instructions executable by one or more processors to perform a method of any of aspects 1 through 21.

Aspect 46: A wireless device for wireless communications, comprising one or more memories storing processor-executable code, and one or more processors coupled with the one or more memories and individually or collectively operable to execute the code to cause the wireless device to perform a method of any of aspects 22 through 42.

Aspect 47: A wireless device for wireless communications, comprising at least one means for performing a method of any of aspects 22 through 42.

Aspect 48: A non-transitory computer-readable medium storing code for wireless communications, the code comprising instructions executable by one or more processors to perform a method of any of aspects 22 through 42.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a’,” or “based at least in part on ‘a,’” may be based on “a” alone or based on a combination of “a” and one or more other factors, conditions, or information. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
transmit a preamble of a physical layer protocol data unit (PPDU), wherein a first portion of the preamble comprises at least a legacy signal (L-SIG) field;
wherein a second portion of the preamble comprises at least a first extended long range (ELR) signature field indicating that the PPDU is associated with ELR communications, the first ELR signature field carrying a first sequence recognized by a second wireless device and occupying at least a first plurality of tones of at least a first symbol of the second portion of the preamble, wherein at least the L-SIG field of the first portion of the preamble precedes the first ELR signature field.

2. The first wireless device of claim 1, wherein the second portion of the preamble further comprises a second ELR signature field carrying a second sequence recognized by the second wireless device and occupying a second plurality of tones of a second symbol of the second portion of the preamble, the first ELR signature field preceding the second ELR signature field in the second portion of the preamble.

3. The first wireless device of claim 2, wherein the first sequence of the first ELR signature field is equivalent to the second sequence of the second ELR signature field.

4. The first wireless device of claim 2, wherein the second sequence of the second ELR signature field is different from the first sequence of the first ELR signature field.

5. The first wireless device of claim 2, wherein the second plurality of tones is different from the first plurality of tones.

6. The first wireless device of claim 2, wherein the second plurality of tones is the same as the first plurality of tones.

7. The first wireless device of claim 2, wherein the first ELR signature field is transmitted according to a first modulation scheme, and the second ELR signature field is transmitted according to a second modulation scheme.

8. The first wireless device of claim 2, wherein the first ELR signature field and the second ELR signature field are transmitted according to a same modulation scheme.

9. The first wireless device of claim 2, wherein the second portion of the preamble further comprises a third ELR signature field carrying a third sequence recognized by the second wireless device and occupying a third plurality of tones of a third symbol of the second portion of the preamble, the second ELR signature field preceding the third ELR signature field in the second portion of the preamble.

10. The first wireless device of claim 9, wherein the third sequence of the third ELR signature field is a repetition of the first sequence of the first ELR signature field.

11. The first wireless device of claim 1, wherein the first ELR signature field occupies a subset of the first plurality of tones.

12. The first wireless device of claim 1, wherein the first portion of the preamble of the PPDU further includes a repeat legacy signal (RL-SIG) field, and the RL-SIG field of the first portion of the preamble precedes the first ELR signature field.

13. The first wireless device of claim 1, wherein the first portion of the preamble of the PPDU includes one or more universal signal (U-SIG) fields, and the one or more U-SIG fields of the first portion of the preamble precede the first ELR signature field.

14. The first wireless device of claim 1, wherein the first sequence of the first ELR signature field is transmitted according to a modulation scheme that is in accordance with a binary phase shift keying (BPSK) modulation associated with a phase rotation.

15. The first wireless device of claim 14, wherein the modulation scheme comprises one of the BPSK modulation scheme, a quadrature BPSK (QBPSK) modulation scheme, a reversed BPSK modulations scheme, a combination of the BPSK modulation scheme and the QBPSK modulation scheme, a combination of the BPSK modulation scheme and the reversed BPSK modulation scheme.

16. The first wireless device of claim 1, wherein the first ELR signature field is partially inverse to the L-SIG field.

17. The first wireless device of claim 1, wherein the first ELR signature field further indicates a basic service set identifier associated with the ELR communications.

18. The first wireless device of claim 1, wherein the first ELR signature field is equivalent to a legacy long training field (L-LTF) included in the first portion of the preamble of the PPDU.

19. The first wireless device of claim 1, wherein the first sequence of the first ELR signature field comprises a sequence associated with a universal signal (U-SIG) field with a physical version number associated with the ELR communications.

20. The first wireless device of claim 1, wherein the first sequence of the first ELR signature field is selected in accordance with a peak to average power ratio (PAPR) associated with the ELR communications.

21. The first wireless device of claim 1, wherein channel estimation of a channel between the first wireless device and the second wireless device are measured in accordance with the first plurality of tones of the first symbol used to transmit the first ELR signature field.

22. A wireless device, comprising:
a processing system that includes processor circuitry and memory circuitry that stores code, the processing system configured to cause the wireless device to:
receive a preamble of a physical layer protocol data unit (PPDU), wherein a first portion of the preamble comprises at least a legacy signal (L-SIG) field;
wherein a second portion of the preamble comprises at least a first extended long range (ELR) signature field indicating that the PPDU is associated with ELR communications, the first ELR signature field carrying a first sequence recognized by the wireless device and occupying at least a first plurality of tones of at least a first symbol of the second portion of the preamble, wherein at least the L-SIG field of the first portion of the preamble precedes the first ELR signature field.

23. The wireless device of claim 22, wherein the second portion of the preamble further comprises a second ELR signature field carrying a second sequence recognized by the wireless device and occupying a second plurality of tones of a second symbol of the second portion of the preamble, the first ELR signature field preceding the second ELR signature field in the second portion of the preamble.

24. The wireless device of claim 23, wherein the second portion of the preamble further comprises a third ELR signature field carrying a third sequence recognized by the wireless device and occupying a third plurality of tones of a third symbol of the second portion of the preamble, the second ELR signature field preceding the third ELR signature field in the second portion of the preamble.

25. A method for wireless communications at a first wireless device, comprising:
transmitting a preamble of a physical layer protocol data unit (PPDU), wherein a first portion of the preamble comprises at least a legacy signal (L-SIG) field;
wherein a second portion of the preamble comprises at least a first extended long range (ELR) signature field indicating that the PPDU is associated with ELR communications, the first ELR signature field carrying a first sequence recognized by a second wireless device and occupying at least a first plurality of tones of at least a first symbol of the second portion of the preamble, wherein at least the L-SIG field of the first portion of the preamble precedes the first ELR signature field.

26. The method of claim 25, wherein the second portion of the preamble further comprises a second ELR signature field carrying a second sequence recognized by the second wireless device and occupying a second plurality of tones of a second symbol of the second portion of the preamble, the first ELR signature field preceding the second ELR signature field in the second portion of the preamble.

27. The method of claim 26, wherein the second portion of the preamble further comprises a third ELR signature field carrying a third sequence recognized by the second wireless device and occupying a third plurality of tones of a third symbol of the second portion of the preamble, the second ELR signature field preceding the third ELR signature field in the second portion of the preamble.

28. A method for wireless communications at a wireless device, comprising:
receiving a preamble of a physical layer protocol data unit (PPDU), wherein a first portion of the preamble comprises at least a legacy signal (L-SIG) field;
wherein a second portion of the preamble comprises at least a first extended long range (ELR) signature field indicating that the PPDU is associated with ELR communications, the first ELR signature field carrying a first sequence recognized by the wireless device and occupying at least a first plurality of tones of at least a first symbol of the second portion of the preamble, wherein at least the L-SIG field of the first portion of the preamble precedes the first ELR signature field.

29. The method of claim 28, wherein the second portion of the preamble comprises a second ELR signature field carrying a second sequence recognized by the wireless device and occupying a second plurality of tones of a second symbol of the second portion of the preamble, the first ELR signature field preceding the second ELR signature field in the second portion of the preamble.

30. The method of claim 29, wherein the second portion of the preamble comprises a third ELR signature field carrying a third sequence recognized by the wireless device and occupying a third plurality of tones of a third symbol of the second portion of the preamble, the second ELR signature field preceding the third ELR signature field in the second portion of the preamble.
